(19) United States
(12) Patent Application Publication
(10) Pub. No.: US 2026/0069478 A1
(43) Pub. Date: Mar. 12, 2026

(54) OFFLOADER SYSTEMS

(71) Applicant: Sage Products, LLC, Cary, IL (US)

(72) Inventors: Becker Ardahji, Palatine, IL (US); Kristin Sexton, Lake in the Hills, IL (US)

(21) Appl. No.: 19/326,132

(22) Filed: Sep. 11, 2025

Related U.S. Application Data
(60) Provisional application No. 63/693,780, filed on Sep. 12, 2024.

(51) Int. Cl. A61G 7/057; A61G 7/07; A61G 7/075

(52) U.S. Cl. CPC A61G 7/05715; A61G 7/05723; A61G 7/05769; A61G 7/07; A61G 7/0755; A61G 2200/327

(57) ABSTRACT

An offloader system includes a main support. The main support includes a main support body and a main cover. The main support body has a main rounded surface with a first edge. The main cover extends around the main support body. The main cover is formed from a polymeric material. The offloader system also includes an auxiliary support. The auxiliary support includes an auxiliary support body and an auxiliary cover. The auxiliary support body has an auxiliary rounded surface with a second edge. The auxiliary cover extends around the auxiliary support body. The auxiliary cover is formed from a polymeric material. The auxiliary cover is hingedly coupled to the main cover along the first edge and the second edge so that the auxiliary support is rotatable relative to the main support.

### CROSS-REFERENCE TO RELATED PATENT APPLICATION

The application claims priority to and the benefit of U.S. Provisional Patent Application No. 63/693,780, filed Sep. 12, 2024, the disclosure of which is incorporated herein by reference in its entireties for all purposes.

### TECHNICAL FIELD

The present disclosure relates generally to offloaders for use to offload pressure from patients.

### BACKGROUND

Caregivers may outfit or provide a patient positioned on a bed with structures to provide comfort to the patients and to protect the patient from effects of the patient being positioned on the bed. For example, caregivers may outfit or provide the patient with structures configured to increase the comfort of the patient and protect the patient from pressure injuries. Some pressure injuries may, for example, occur due to prolonged pressure on a patient's skin from a bed. Further, the caregivers may use pillows to offload pressure from specific parts of the patient's body. However, it may be difficult for caregivers to desirably adjust the pillows to properly offload pressure. For example, the pillows may be uncomfortable to the patient and it may be difficult for a caregiver to properly position each pillow relative to the other pillows.

### SUMMARY

In one embodiment, an offloader system includes a main support and an auxiliary support. The main support includes a main support body and a main cover. The main support body has a main rounded surface with a first edge. The main cover extends around the main support body. The main cover is formed from a polymeric material. The auxiliary support includes an auxiliary support body and an auxiliary cover. The auxiliary support body has an auxiliary rounded surface with a second edge. The auxiliary cover extends around the auxiliary support body. The auxiliary cover is formed from a polymeric material. The auxiliary cover is hingedly coupled to the main cover along the first edge and the second edge so that the auxiliary support is rotatable relative to the main support.

In another embodiment, an offloader system includes a main support. The main support includes a main support body and a main cover. The main support body has a main ramp surface with a first edge having a first length. The main cover extends around the main support body. The offloader system also includes a first auxiliary support. The first auxiliary support body includes a first auxiliary support body and a first auxiliary cover. The first auxiliary support body has a first auxiliary ramp surface with a second edge having a second length and a first side surface. The first auxiliary cover extends around the first auxiliary support body. The first auxiliary cover is hingedly coupled to the main cover along the first edge and the second edge so that the first auxiliary support is rotatable relative to the main support. The offloader system also includes a second auxiliary support. The second auxiliary support includes a second auxiliary support body and a second auxiliary cover. The second auxiliary support body has a second auxiliary ramp surface with a third edge and a second side surface facing the first side surface. The second auxiliary cover extends around the second auxiliary support body. The second auxiliary cover is hingedly coupled to the main cover along the first edge and the third edge having a third length so that the second auxiliary support is rotatable relative to the main support. The second length is 20% to 40% of the first length, inclusive. The third length is 20% to 40% of the first length, inclusive. The first side surface and the second side surface are separated by a fourth length, the fourth length is 20% to 40% of the first length, inclusive.

In another embodiment, an offloader system includes a main support and a first valve. The main support is defined by a first edge and a second edge opposite the first edge. The main support includes an inner core, a first sheet, and a second sheet. The inner core includes a foam and defines a cavity positioned at the second edge. The first sheet and the second sheet include a polymeric material. The second sheet is coupled to the first sheet along a periphery of the first sheet and cooperates with first sheet to form a cover. The cover extends around and encloses the inner core to form an inflatable cushion. The first valve is coupled to the cover and is positioned along the first edge. The first valve is in fluid communication with the inflatable cushion and configured to facilitate flow of fluid into the inflatable cushion.

### BRIEF DESCRIPTION OF THE DRAWINGS

The details of one or more implementations are set forth in the accompanying drawings and the description below. Other features, aspects, and advantages of the disclosure will become apparent from the description, the drawings, and the claims, in which:

FIG. 1 is a block diagram of an example patient support system including an example offloader system;

FIG. 2 is a perspective view of an example offloader system;

FIG. 3 is a bottom view of the offloader system of FIG. 2;

FIG. 4 is a side view of the example offloader system of FIG. 2;

FIG. 5 is a top view of the example offloader system of FIG. 2;

FIG. 6 is a top view of the example offloader system of FIG. 2;

FIG. 7 is a side view of the example offloader system of FIG. 2;

FIG. 8 is a perspective view of the example offloader system of FIG. 2 supporting a limb;

FIG. 9 is a cross-sectional view of the example offloader system of FIG. 2;

FIG. 10 is a perspective view of another example offloader system in a first position;

FIG. 11 is another perspective view of the offloader system of FIG. 10 supporting a limb;

FIG. 12 is a side view of the offloader system of FIG. 10;

FIG. 13 is a front view of the offloader system of FIG. 10;

FIG. 14 is a top view of the offloader system of FIG. 10;

FIG. 15 is top view of the offloader system of FIG. 10 in a transition position;

FIG. 16 is a perspective view of the offloader system of FIG. 10 in a second position;

FIG. 17 is a perspective view of another example offloader system in a deflated state;

FIG. 18 is another perspective view of the offloader system of FIG. 17;

FIG. 19 is a perspective view of an inner core of the offloader system of FIG. 17;

FIG. 20 is another perspective view of the offloader system of FIG. 17 during inflation;

FIG. 21 is another perspective view of the offloader system of FIG. 17 supporting a portion of a patient;

FIG. 22 is a top view of another example offloader system in a deflated state;

FIG. 23 is another perspective view of the offloader system of FIG. 22 supporting a portion of a patient;

FIG. 24 is another perspective view of the offloader system of FIG. 22 with a portable air blower;

FIG. 25 is another perspective view of the offloader system of FIG. 22 during inflation;

FIG. 26 is a perspective view of another example offloader system;

FIG. 27 is another perspective view of the offloader system of FIG. 26;

FIG. 28 is top view of the offloader system of FIG. 26;

FIG. 29 is an exploded perspective view of the offloader system of FIG. 26;

FIG. 30 is a perspective view of an inner core of the offloader system of FIG. 26;

FIG. 31 is another perspective view of the inner core of the offloader system of FIG. 26;

FIG. 32 is a perspective view of another example offloader system;

FIG. 33 is a perspective view of an example pump system;

FIG. 34 is a perspective view of another example offloader system;

FIG. 35 is a top view of the offloader system of FIG. 34;

FIG. 36 is a top view of two example offloader systems; and

FIG. 37 is a bottom view of the two offloader systems of FIG. 36.

### DETAILED DESCRIPTION

Before turning to the Figures, which illustrate certain example embodiments in detail, it should be understood that the present disclosure is not limited to the details or methodology set forth in the description or illustrated in the Figures. It should also be understood that the terminology used herein is for the purpose of description only and should not be regarded as limiting.

### I. Overview

Caregivers typically perform “Q2” turning (e.g., turning a patient every 2 hours) to prevent pressure ulcers, promote circulation, etc. The caregivers can use multiple pillows to reposition the patient, and insert pillows under specific body parts to offload pressure from those body parts. Utilizing pillows to perform offloading on specific parts of a patient's body may be uncomfortable, increase use of resources, and may be difficult for a caregiver to perform.

Implementations herein are directed towards embodiments of offloader systems (e.g., offloader device). The offloader systems can be used multiple times and in multiple configurations, thereby avoiding a usage of multiple pillows and uncomfortable configurations of the pillows. Additionally, the offloader systems described herein enable caregivers to attain increased efficiency in rendering care to patients because the offloader systems can be used to support a patient more quickly than pillows, for example.

One offloader system described herein includes a main support and an auxiliary support. The main support and the auxiliary support are each covered by a polymeric material and are hingedly coupled so that the auxiliary support is rotatable relative to the main support. Due to the hinged connection, the offloader system is capable of being utilized in multiple positions. Each of these positions enables the caregiver to configure the offloader system to optimally support and comfort to the patient. For example, to provide support to a patient's back, the offloader system includes a portion with a rounded surface as a top surface, and the caregiver inserts the offloader system underneath the patient's back. The offloader system is also capable of defining a receptacle. The receptacle can receive and hold a limb of the patient's body (e.g., arm, leg). The offloader system also includes a sheet. The sheet includes a portion formed from a material with a higher coefficient of static friction than the polymeric material. The sheet can be detachably coupled to the main support, and resist movement of the patient's body along a surface (e.g., a surface of a bed).

Another offloader system described herein includes a main support, a first auxiliary support, and a second auxiliary support. Both the first auxiliary support and the second auxiliary support are hingedly coupled to the main support, enabling use of the offloader system in multiple positions. The offloader system is capable of defining a receptacle. The first auxiliary support and the second auxiliary support are coupled to an edge of the main support, and are spaced apart by a length. The offloader system also includes one or more straps. The one or more straps are coupled to the main support and at least one of the first auxiliary support or the second auxiliary support. The straps enable securing a patient's limb to the offloader system. For example, an arm of the patient may be placed in the receptacle defined by the offloader system and the one or more straps may extend above the arm and secure the arm to the offloader system.

Another offloader system described herein includes a main support and a first valve. The main support includes an inner core, a first sheet, and a second sheet. The second sheet is coupled to the first sheet along a periphery of the first sheet and cooperates with first sheet to form a cover. The cover extends around and encloses the inner core to form an inflatable cushion. The inflatable cushion may be inflated via an external pump or a cartridge placed within the main support at the first valve. The main support is configured to optimally support and comfort to the patient. For example, to provide support to a patient's sacrum, the offloader system includes a cavity, in which the caregiver places the cavity underneath the patient's sacrum and inflate the main body to properly offload the boney prominences (e.g., tailbone) of the region.

### II. Overview of Example Patient Support System

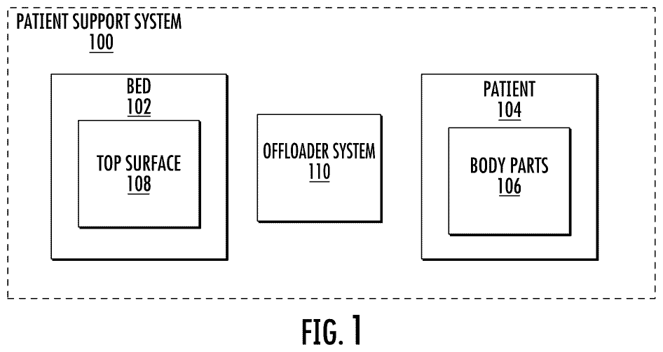

FIG. 1 depicts a patient support system 100 (e.g., bed system). The patient support system 100 includes a bed 102 (e.g., hospital bed, medical bed, patient bed, cot, transport surface, stretcher, table). The bed 102 supports a patient 104. As is described in more detail herein, body parts 106 (e.g., arms, legs, back, head) of the patient 104 are supported on the bed 102.

The bed 102 includes a top bed surface 108. The patient 104 rests on the top bed surface 108. The top bed surface 108 may include a cushioning material (e.g., foam, cotton, latex). In one example application, a back of the patient is in contact with the top bed surface 108. The top bed surface 108 may be covered with a covering material such as, for example, a polymeric material (e.g., nylon, polyester, acrylic, olefin (polypropylene), vinyl-coated fabrics, polyurethane (PU)-coated fabrics, elastane, microfiber).

The patient support system 100 further includes an offloader system 110 (e.g., pressure reliever, weight redistributor, cushion). The offloader system 110 reduces and redistributes a weight, load, or pressure of the body parts 106 and supports the body parts 106 on the bed 102. For example, the offloader system 110 may be placed underneath a back of the patient 104 to alleviate pressure on the back. When utilized in this manner, the offloader system 110 may mitigate development of pressure ulcers (e.g., bedsores) on the back. The offloader system 110 is also configured to promote blood circulation for the patient 104 and mitigate further injury (e.g., pressure ulcers) to the patient 104. The offloader system 110 is placed (e.g., in contact with) on the top bed surface 108.

### III. Overview of First Example Offloader System

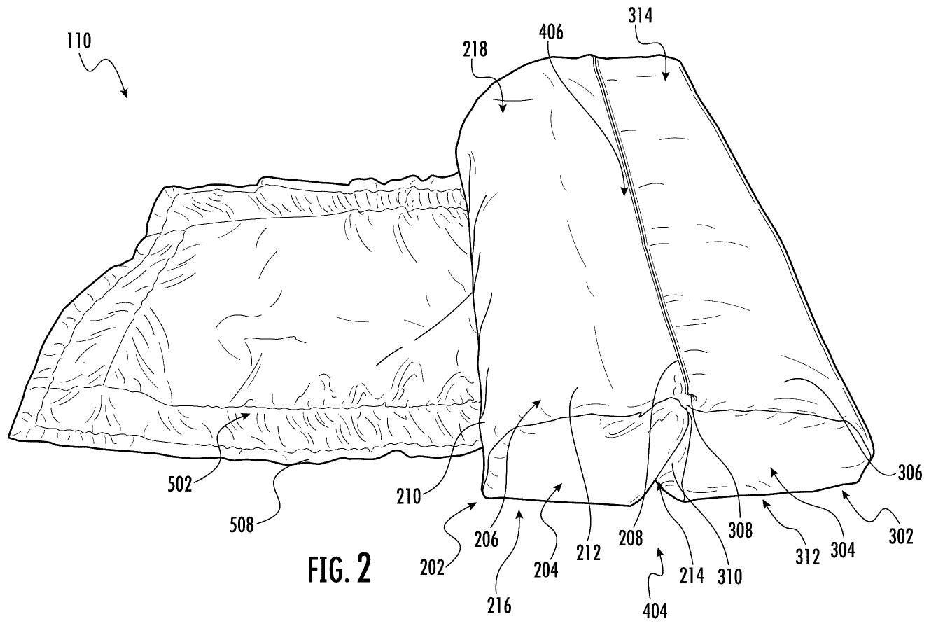

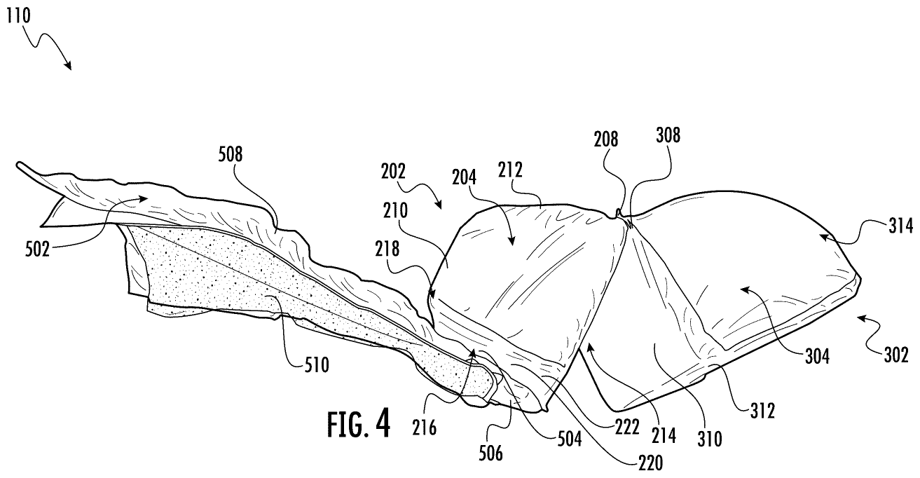

FIGS. 2-9 depict various views of an example offloader system 110, according to an embodiment. The offloader system 110 includes a main support 202. The main support 202 is configured to support the body parts 106. For example, the main support 202 reduces pressure on the body parts 106 by being placed underneath the body parts 106.

The main support 202 includes a main support body 204. In various embodiments, the main support body 204 includes a main rounded surface 206. The main rounded surface 206 has a first edge 208. The first edge 208 extends along a length of the main support body 204. The main rounded surface 206 also has a straight portion 210 and a rounded portion 212. The rounded portion 212 is convex with respect the straight portion 210. The rounded portion 212 is contiguous with the first edge 208. In some embodiments, the straight portion 210 is rounded. In some embodiments, the rounded portion 212 is partially straight and partially rounded.

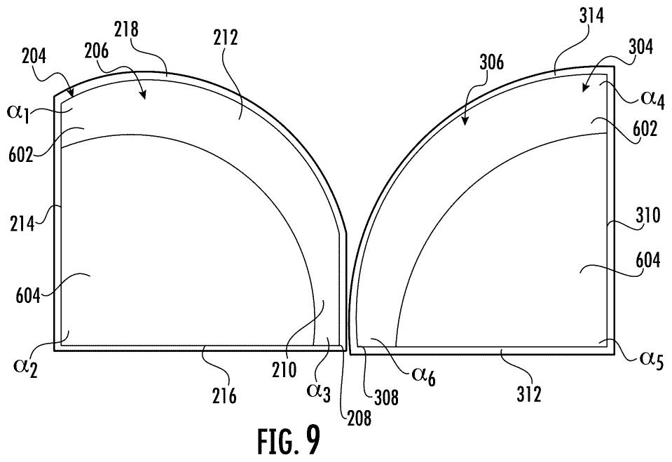

The main support body 204 also includes a main lateral wall 214. The main lateral wall 214 is contiguous with the first edge 208. As seen in, for example, FIG. 9, the main lateral wall 214 is separated from the rounded portion 212 by a first angle α₁. In various embodiments, the first angle α₁ is between 70 degrees and 90 degrees, inclusive.

The main support body 204 further includes a main base wall 216. The main base wall 216 is contiguous with the main lateral wall 214 and the straight portion 210. The main base wall 216 and the main lateral wall 214 are separated by a second angle α₂. In various embodiments, the second angle α₂ is between 70 degrees and 90 degrees, inclusive. The main base wall 216 is separated from the straight portion 210 by a third angle α₃. In various embodiments, the second angle α₂ is between 70 degrees and 90 degrees, inclusive.

The main support 202 also includes a main cover 218. The main cover 218 extends around (e.g., covers) at least a portion of the main support body 204. In various embodiments, the main cover 218 covers the main support body 204 (e.g., the main cover 218 covers an entirety of the main support body 204).

In some embodiments, the main cover 218 is formed from a polymeric material. The polymeric material is non-absorbent (e.g., water repellant, cleanable). For example, the polymeric material is at least one of nylon, polyester, acrylic, olefin (polypropylene), vinyl-coated fabrics, PU-coated fabrics, elastane, microfiber, spacer material, etc. The spacer material (e.g., spacer fabric) can allow for enhanced airflow and breathability compared to, for example, polyester. The spacer material can also regulate temperature and moisture better than, for example, a material of the main support body 204, such as foam. The spacer material can also be layered to allow for, for example, the body parts 106 to be better immersed in the main support 202. The spacer material can increase a depth at which the body parts 106 can sink into the main support compared to, for example, polyester. The main cover 218 may be replaceable and/or washable. The main cover 218 may include at least one fastener such as a zipper, buttons, hook-and-loop, laces, and/or clasps. The at least one fastener may facilitate replacing and/or washing the main cover 218.

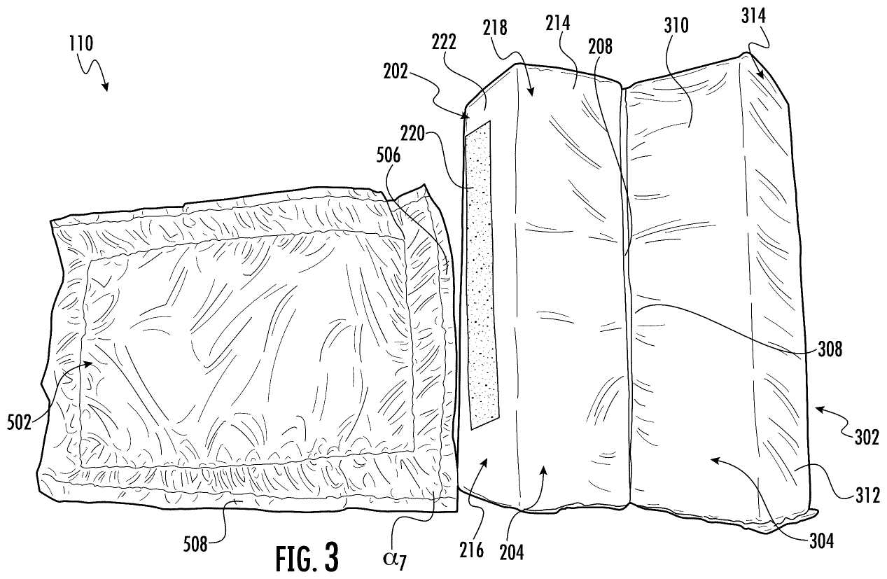

In some embodiments, as seen in FIG. 3, the main support 202 includes a first engagement member 220 disposed on the main cover 218. For example, the first engagement member 220 is disposed on the main cover 218 on a portion 222 of the main cover 218 extending across the main base wall 216. The first engagement member 220 includes at least one of an adhesive strip, buttons, zipper, hook-and-loop, laces, or clasps.

The offloader system 110 includes an auxiliary support 302. The auxiliary support 302 is configured to support the body parts 106. For example, auxiliary support 302 reduces pressure on the body parts 106 by being placed underneath the body parts 106.

The auxiliary support 302 includes an auxiliary support body 304. In various embodiments, auxiliary support body 304 includes an auxiliary rounded surface 306. The auxiliary rounded surface 306 has a second edge 308. The second edge 308 extends along a length of the auxiliary support body 304.

The auxiliary support body 304 also includes an auxiliary lateral wall 310. The auxiliary lateral wall 310 is contiguous with the second edge 308. As seen in, for example, FIG. 9, the auxiliary lateral wall 310 is separated from the auxiliary rounded surface 306 by a fourth angle α₄. In various embodiments, the fourth angle α₄ is between 70 degrees and 90 degrees, inclusive. The auxiliary rounded surface 306 is convex with respect to the auxiliary lateral wall 310.

The auxiliary support body 304 further includes an auxiliary base wall 312. The auxiliary base wall 312 is contiguous with the auxiliary lateral wall 310 and the auxiliary rounded surface 306. The auxiliary base wall 312 and the auxiliary lateral wall 310 are separated by a fifth angle α₅. In various embodiments, the fifth angle α₅ is between 70 degrees and 90 degrees, inclusive. The auxiliary base wall 312 is separated from the auxiliary rounded surface 306 by a sixth angle between 70 degrees and 90 degrees, inclusive.

The auxiliary support 302 further includes an auxiliary cover 314. The auxiliary cover 314 extends around (e.g., covers) at least a portion of the auxiliary support body 304. In various embodiments, the auxiliary cover 314 covers the auxiliary support body 304 (e.g., the auxiliary cover 314 covers an entirety of the auxiliary support body 304).

In some embodiments, the auxiliary cover 314 is formed from a polymeric material. The polymeric material is non-absorbent. For example, the polymeric material is at least one of nylon, polyester, acrylic, olefin (polypropylene), vinyl-coated fabrics, PU-coated fabrics, elastane, microfiber, spacer material, etc. The auxiliary cover 314 may replaceable and/or washable. The auxiliary cover 314 may include at least one fastener such as a zipper, buttons, hook-and-loop, laces, and/or clasps. The at least one fastener may facilitate replacing and/or washing the auxiliary cover 314.

The auxiliary cover 314 is hingedly coupled to the main cover 218 along the first edge 208 and the second edge 308 so that the auxiliary support 302 is rotatable relative to the main support 202. The auxiliary cover 314 is hingedly coupled to the main cover 218 via stitching. In some embodiments, the auxiliary cover 314 is hingedly coupled to the main cover 218 via hinges, staples, adhesives, etc.

In various embodiments, the auxiliary support 302 and the main support 202 are configured such that the auxiliary support 302 is capable of rotating between 0 and 180 degrees, inclusive, relative to the main support 202. A hinged coupling along the first edge 208 and the second edge 308 allows the main rounded surface 206 and the auxiliary rounded surface 306 to face upward (e.g., in contact with the body parts 106, facing opposite the top bed surface 108). For example, the hinged coupling allows for various configurations of the offloader system 110 with the main rounded surface 206 and the auxiliary rounded surface 306 facing upwards in each of the various configurations. This ability to have the main rounded surface 206 and the auxiliary rounded surface 306 facing upward enables a caregiver to provide enhanced comfort to the patient 104.

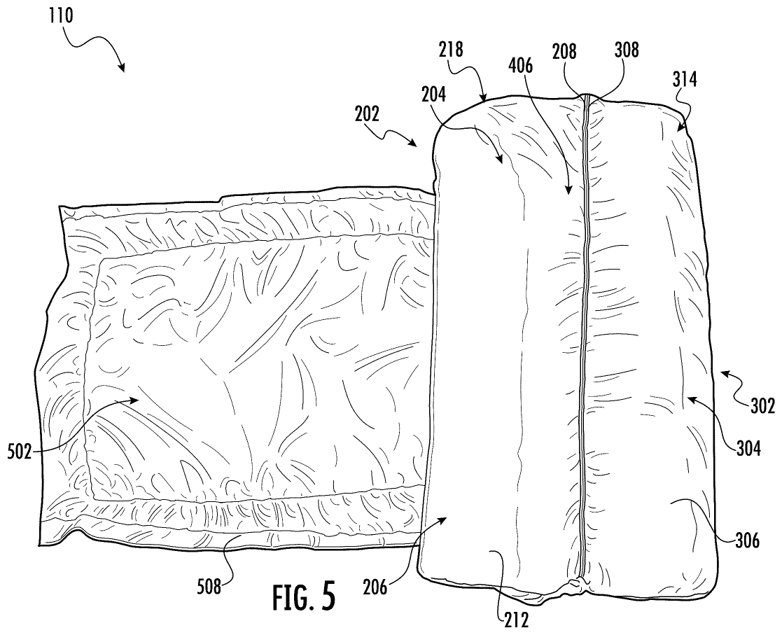

FIGS. 2 and 5 illustrate the offloader system 110 in a first position (e.g., one of the various configurations). In the first position, the main base wall 216 and the auxiliary base wall 312 form a first base surface 404. In some embodiments, the first base surface 404 is in contact with the top bed surface 108 (e.g., the main base wall 216 and the auxiliary base wall 312 are in contact with the top bed surface 108). The main rounded surface 206 and the auxiliary rounded surface 306 form a first top surface 406. The first top surface 406 faces opposite the first base surface 404 and in some embodiments, is in contact with the body parts 106 of the patient 104. The main lateral wall 214 and the auxiliary lateral wall 310 are contiguous in the first position. The main support 202 and the auxiliary support 302 form a semi-cylinder shape in the first position. The offloader system 110 is placed underneath various one of the body parts 106. For example, the offloader system 110 may be placed underneath a back of the patient 104 in the first position.

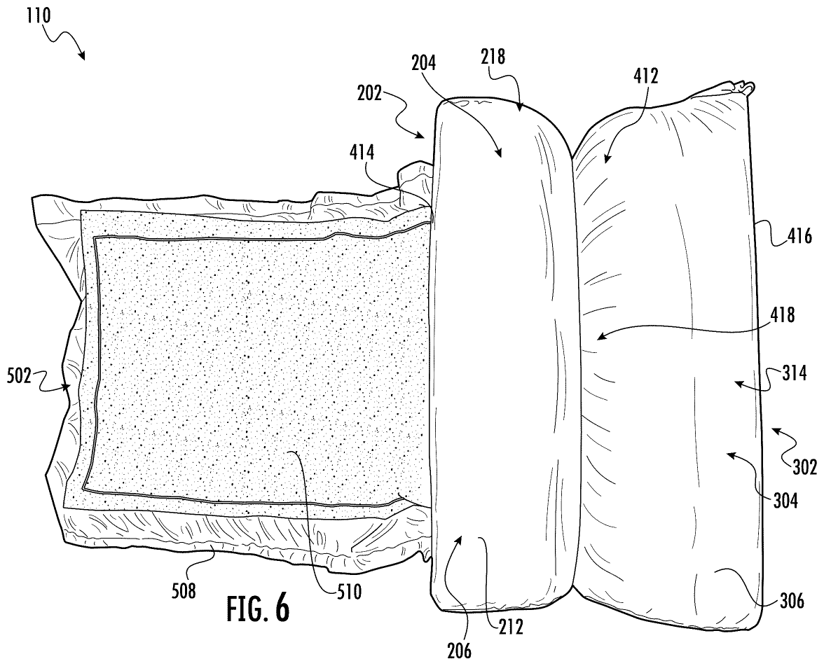

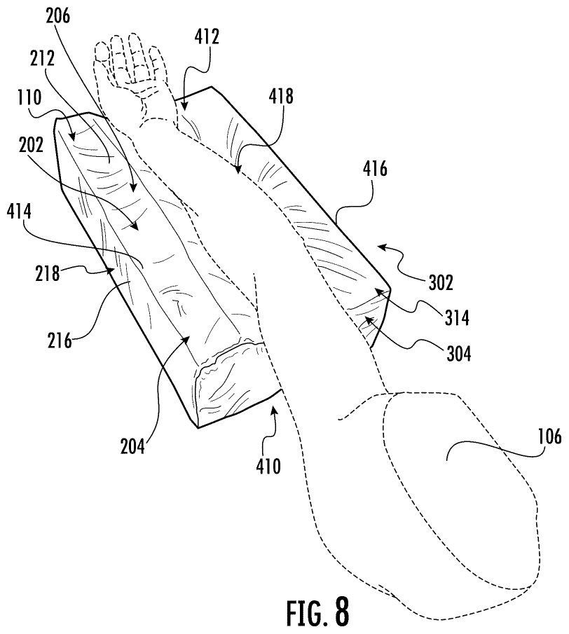

FIGS. 6-8 illustrate the offloader system 110 in a second position (e.g., one of the various configurations). The second position 408 is formed by rotating the auxiliary support 302 via the first edge 208 and the second edge 308. The second position is formed by rotating the auxiliary support 302 180 degrees relative to the first position 402. In the second position 408, the main lateral wall 214 and the auxiliary lateral wall 310 form a second base surface 410. In some embodiments, the second base surface 410 is in contact with the top bed surface 108 (e.g., the main lateral wall 214 and the auxiliary lateral wall 310 in contact with the top bed surface 108). The main rounded surface 206 and the auxiliary rounded surface 306 form a second top surface 412. In further detail, the main base wall 216 and the main rounded surface 206 form a first apex 414. Opposite the first apex 414, the auxiliary base wall 312 and the auxiliary rounded surface 306 form a second apex 416. As seen in FIGS. 6-8, the first apex 414, the second apex 416, the first edge 208, and the second edge 308 define a receptacle 418, the receptacle 418 being the second top surface 412. The receptacle 418 receives and holds the body parts 106 as seen in, for example, FIG. 8.

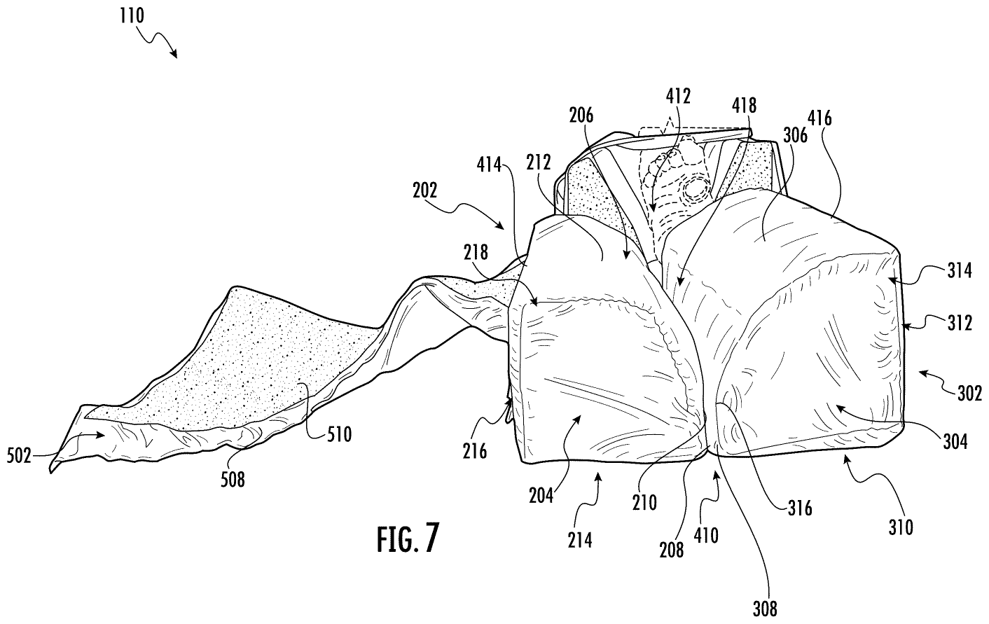

In some embodiments, the second apex 416 has a height greater than a height of the first apex 414 as seen in FIG. 7, for example. In this case, the auxiliary base wall 312 has a height greater than the main base wall 216. In the second position, the straight portion 210 is contiguous with a portion 316 of the auxiliary rounded surface 306.

Referring further to FIGS. 2-7, the offloader system 110 further includes a sheet 502 (e.g., tail). The sheet 502 is detachably coupled to the main support 202 via a second engagement member 504. The second engagement member 504 removably engages with the first engagement member 220, and enables coupling of the sheet 502 with the main support body 204. The second engagement member 504 is at least one of an adhesive strip, buttons, zipper, hook-and-loop, laces, or clasps.

The sheet 502 also includes a first sheet edge 506 and a second sheet edge 508. The second sheet edge 508 is contiguous with the first sheet edge 506. The second sheet edge 508 is separated from the first sheet edge 506 by a seventh angle α₇. In various embodiments, the seventh angle α₇ is between 70 to 100 degrees, inclusive. The first sheet edge 506 includes the second engagement member 504, and is thus detachably coupled to the main support body 204. The sheet 502 has a rectangular shape. For example, the second sheet edge 508 has a sheet length while the first sheet edge 506 has a main support length. In various embodiments, the sheet length is greater than the main support length and less than 4 times the main support length.

As seen in, for example, FIG. 6, the sheet 502 also includes a portion 510 formed from a second material, the second material different than the polymeric material. The portion 510 provides additional securement of the body parts 106 to the offloader system 110. The main cover 218 and the auxiliary cover 314 have a base coefficient of static friction. The second material has a sheet coefficient of static friction. The sheet coefficient of static friction is greater than the base coefficient of static friction. In various embodiments, the sheet coefficient of static friction is greater than 3 times the base coefficient of static friction and less than 5 times the base coefficient of static friction.

The portion 510 mitigates movement of the body part 106 when the body part 106 is in contact with the portion 510. For example, the offloader system 110 is in the first position 402 and located under a wrist of the patient 104. In this case, the portion 510 is located under an elbow of the patient 104 to precent movement of the wrist. The second material is at least one of a fabric or coating. The fabric may be a cotton fabric. The coating may be a rubber, silicone, or PU coating. In some embodiments, the portion 510 is coupled to the sheet 502 via fasteners, stitches, staples, or an adhesive. In some embodiments, the portion 510 is detachably coupled to the sheet 502 via fasteners, zippers, buttons, or adhesive strips.

In some embodiments, the sheet 502 is detachably coupled to both the main support body 204 and the auxiliary support body 304. In this case, the auxiliary support body 304 includes a third engagement member.

In some embodiments, as shown in FIG. 9, the main support body 204 and the auxiliary support body 304 are formed of (e.g., composed of) a first foam 602 and a second foam 604. In some embodiments, the first foam 602 includes gel. The gel can allow for greater shock absorption as well as enhanced comfort and flexibility compared to, for example, foam without gel. In some embodiments, the second foam 604 has a higher density than the first foam 602, with the first foam 602 having a greater compression rate than the second foam 604. For example, the first foam 602 having a greater compression rate than the second foam 604 may enable the main support body 204 and the auxiliary support body 304 to provide a higher immersion of the body parts 106 (e.g., compared to the first foam 602 and the second foam 604 having an equal compression rate) while maintaining support for the body parts 106. This may provide increased comfort to the patient 104. This may also provide increase a surface area of the main support body 204 and the auxiliary support body 304 to the body parts 106. This may reduce a pressure on the body parts 106 as a force (e.g., weight of the body parts 106) is distributed over a greater area. In some embodiments, the second foam 604 has a greater thickness than the first foam 602. This may enable the second foam 604 to support the greater compression rate of the first foam 602 and redistribute a load (e.g., weight, pressure) received from the first foam 602.

In some embodiments, the first foam 602 corresponds to the main rounded surface 206 and the auxiliary rounded surface 306. In this case, the first foam 602 cushions the body parts 106 while the body part 106 contacts the main cover 218 and the auxiliary cover 314. In some embodiments, the second foam 604 corresponds to the main base wall 216 and the auxiliary base wall 312.

In some embodiments, the offloader system 110 does not include the auxiliary support 302. In some embodiments, the offloader system 110 does not include the sheet 502. In this case, the main support 202 does not include the first engagement member 220.

### IV. Overview of Second Example Offloader System

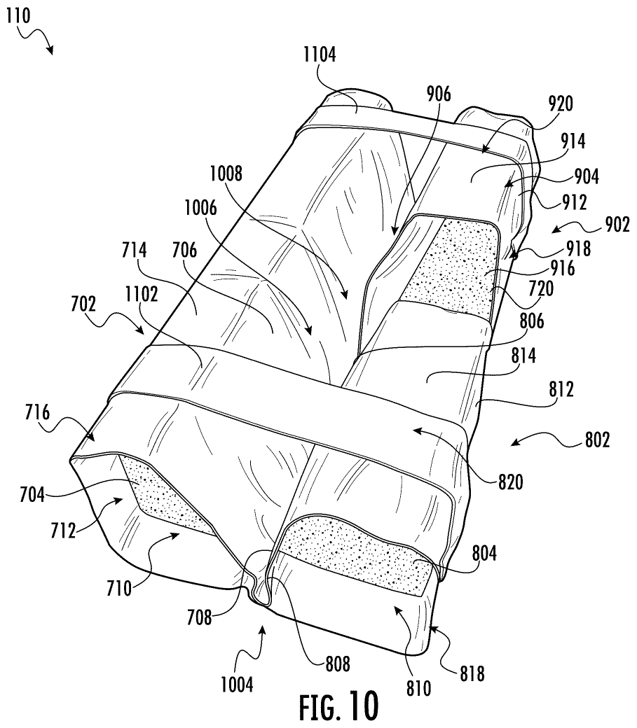

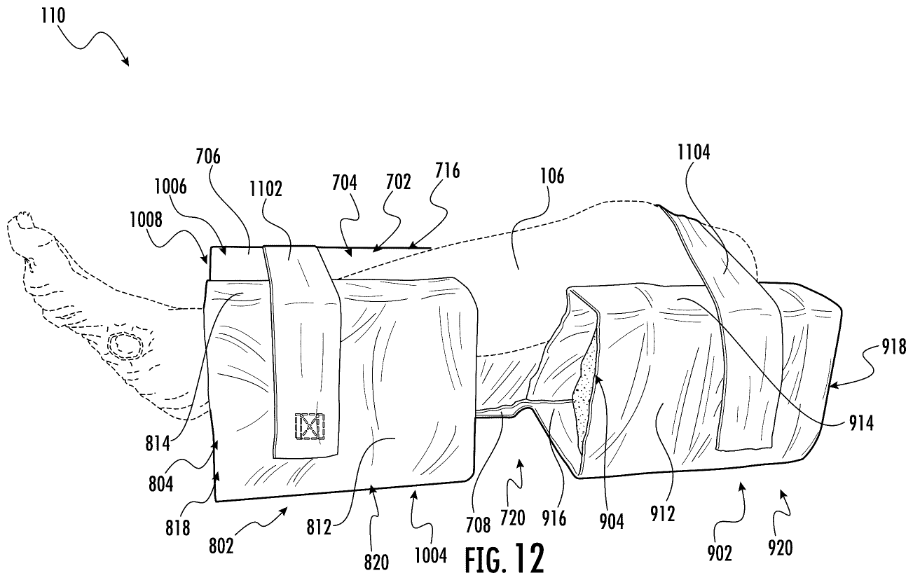

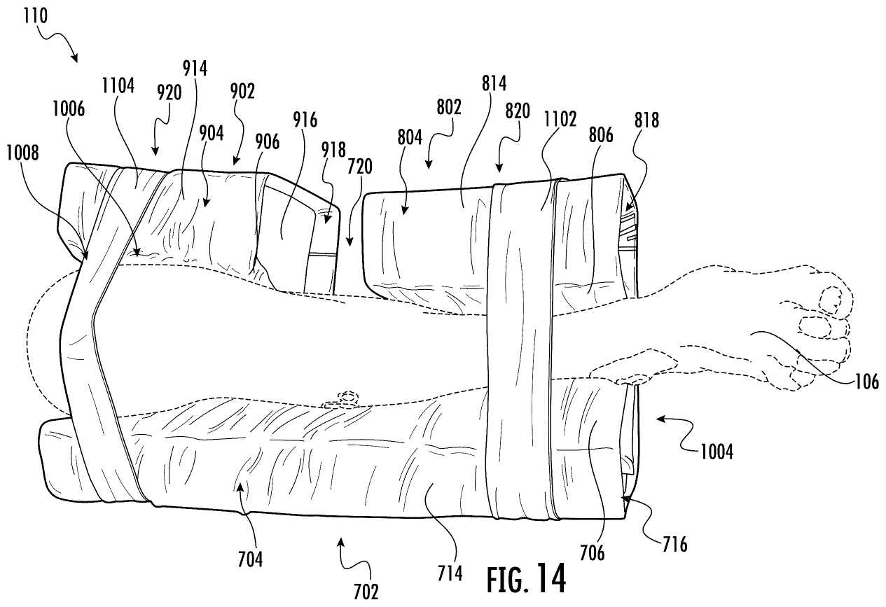

FIGS. 10-16 depict various views of another example offloader system 110, according to an embodiment. The offloader system 110 includes a main support 702. The main support 702 is configured to support the body parts 106. For example, the main support 702 reduces pressure on the body parts 106 by placing the main support 702 underneath the body parts 106.

The main support 702 includes a main support body 704. The main support body 704 is formed from a third material. In some embodiments, the third material is a foam and in other embodiments, the third material includes the first foam 602 and the second foam 604. The main support body 704 includes a main ramp surface 706. The main ramp surface 706 has a first edge 708. The first edge 708 extends along a length of the main support body 704. The first edge 708 has a first length.

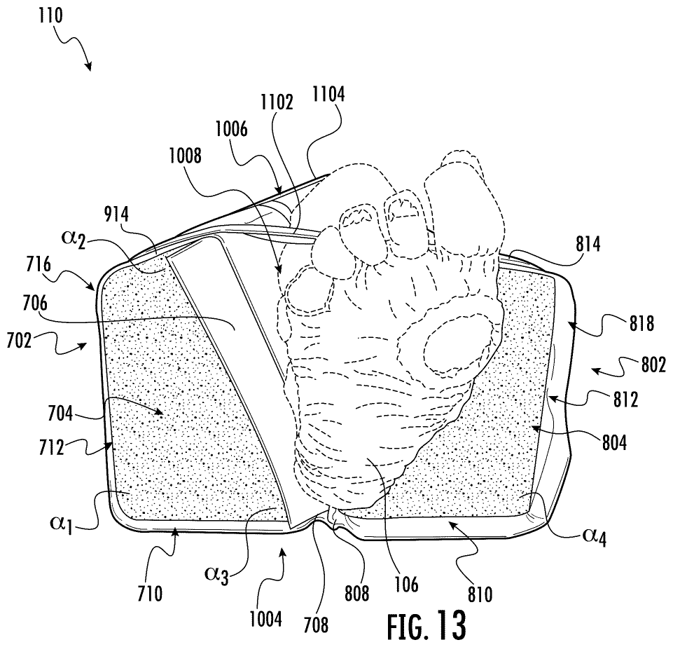

The main support body 704 further includes a main base wall 710. The main base wall 710 is contiguous with the first edge 708. The main support body 704 also includes a main lateral wall 712. The main lateral wall 712 contiguous with the main base wall 710. As seen in, for example, FIG. 13, the main base wall 710 and the main lateral wall 712 are separated by a first angle α₁. In various embodiments, the first angle α₁ is between 70 degrees and 90 degrees, inclusive.

The main support body 704 further includes a main top wall 714. The main top wall 714 is contiguous with the main lateral wall 712 and the main ramp surface 706. The main top wall 714 and the main ramp surface 706 are separated by a second angle α₂. In various embodiments, the second angle α₂ is between 50 degrees and 80 degrees, inclusive. The main ramp surface 706 and the main base wall 710 are separated by a third angle α₃. In various embodiments, the third angle as is between 50 degrees and 90 degrees, inclusive. In some embodiments, the main ramp surface 706 is rounded and convex relative to the main base wall 710 and the main top wall 714.

The main support 702 further includes a main cover 716. The main cover 716 extends around (e.g., covers) at least a portion of the main support body 704. In various embodiments, the main cover 716 covers the main support body 704 (e.g., the main cover 716 covers an entirety of the main support body 704.

In some embodiments, the main cover 716 is formed from a polymeric material. The polymeric material is non-absorbent (e.g., water repellant, cleanable). For example, the polymeric material is at least one of nylon, polyester, acrylic, olefin (polypropylene), vinyl-coated fabrics, PU-coated fabrics, elastane, microfiber, spacer material, etc. The main cover 716 may be replaceable and/or washable. The main cover 716 may include at least one fastener such as a zipper, buttons, hook-and-loop, laces, and/or clasps. The at least one fastener may facilitate replacing and/or washing the main cover 716.

The offloader system 110 includes a first auxiliary support 802. The first auxiliary support 802 is configured to support the body parts 106. For example, the first auxiliary support 802 reduces pressure on the body parts 106 by placing the first auxiliary support 802 underneath the body parts 106.

The first auxiliary support 802 includes a first auxiliary support body 804 formed from the third material. The first auxiliary support body 804 includes a first auxiliary ramp surface 806. The first auxiliary ramp surface 806 has a second edge 808. The second edge 808 extends along a length of the first auxiliary support body 804. The second edge 808 has a second length. The second length is 20% to 40% of the first length, inclusive.

The first auxiliary support body 804 further includes a first auxiliary base wall 810. The first auxiliary base wall 810 is contiguous with the second edge 808. The first auxiliary support body 804 also includes a first auxiliary lateral wall 812. The first auxiliary lateral wall 812 is contiguous with the first auxiliary base wall 810. The first auxiliary base wall 810 and the first auxiliary lateral wall 812 are separated by a fourth angle α₄. In various embodiments, the fourth angle α₄ is between 70 degrees and 90 degrees, inclusive.

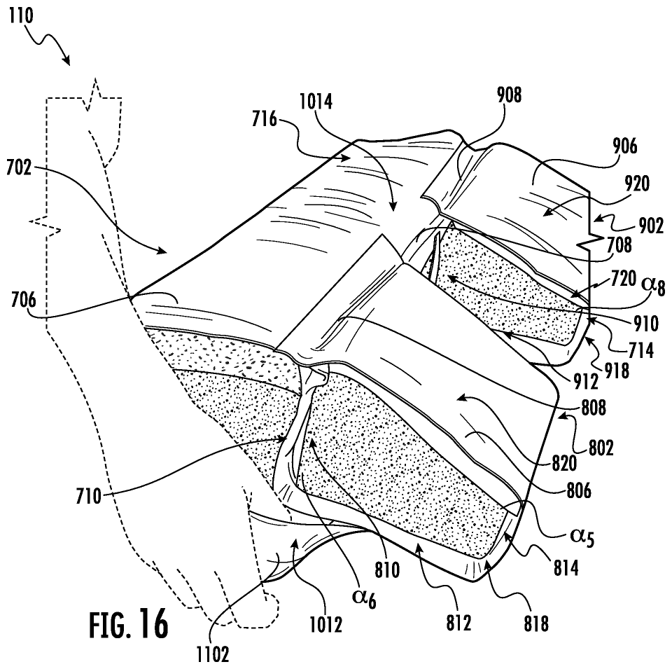

The first auxiliary support body 804 further includes a first auxiliary top wall 814. The first auxiliary top wall 814 is contiguous with the first auxiliary lateral wall 812 and the first auxiliary ramp surface 806. As seen in, for example, FIG. 16, the first auxiliary top wall 814 and the first auxiliary ramp surface 806 are separated by a fifth angle as. In various embodiments, the fifth angle α₅ is between 50 degrees and 80 degrees, inclusive. The first auxiliary ramp surface 806 and the first auxiliary base wall 810 are separated by a sixth angle α₆. In various embodiments, the sixth angle α₆ is between 50 degrees and 90 degrees, inclusive.

The first auxiliary support body 804 further includes a first side surface 816. The first side surface 816 is contiguous with the first auxiliary ramp surface 806, the first auxiliary base wall 810, the first auxiliary lateral wall 812, and the first auxiliary top wall 814. In some embodiments, the first auxiliary ramp surface 806 is rounded and convex relative to the first auxiliary base wall 810 and the first auxiliary top wall 814.

The first auxiliary support 802 further includes a first auxiliary cover 818. The first auxiliary cover 818 extends around (e.g., covers) at least a portion of the first auxiliary support body 804. In various embodiments, the first auxiliary cover 818 covers the first auxiliary support body 804 (e.g., the first auxiliary cover 818 covers an entirety of the first auxiliary support body 804).

In some embodiments, the first auxiliary cover 818 is formed from a polymeric material. The polymeric material is non-absorbent (e.g., water repellant, cleanable). For example, the polymeric material is at least one of nylon, polyester, acrylic, olefin (polypropylene), vinyl-coated fabrics, PU-coated fabrics, elastane, microfiber, spacer material, etc. The first auxiliary cover 818 may be replaceable and/or washable. The first auxiliary cover 818 may include at least one fastener such as a zipper, buttons, hook-and-loop, laces, and/or clasps. The at least one fastener may facilitate replacing and/or washing the main cover 218.

The first auxiliary cover 818 is hingedly coupled to the main cover 716 along the first edge 708 and the second edge 808 so that the first auxiliary support 802 is rotatable relative to the main support 702. The first auxiliary cover 818 is hingedly coupled to the main cover 716 via stitching. In some embodiments, the first auxiliary cover 818 is hingedly coupled to the main cover 716 via hinges, staples, adhesives, etc.

In various embodiments, the first auxiliary support 802 and the main support 702 are configured such that the first auxiliary support 802 is capable of rotating between 0 and 180 degrees, inclusive, relative to the main support 702. A hinged coupling along the first edge 708 and the second edge 808 allows the main ramp surface 706 and the first auxiliary ramp surface 806 to face upward (e.g., in contact with the body parts 106, facing opposite the top bed surface 108). For example, the hinged coupling allows for various configurations of the offloader system 110 with the main ramp surface 706 and the first auxiliary ramp surface 806 facing upwards in each of the various configurations.

The offloader system 110 includes a second auxiliary support 902. The second auxiliary support 902 is configured to support the body parts 106. For example, the second auxiliary support 902 reduces pressure on the body parts 106 by placing the second auxiliary support 902 underneath the body parts 106.

The second auxiliary support 902 includes a second auxiliary support body 904 formed from the fourth material. The second auxiliary support body 904 includes a second auxiliary ramp surface 906. The second auxiliary ramp surface 906 has a third edge 908. The third edge 908 extends along a length of the second auxiliary support body 904. The third edge 908 has a third length. The third length is 20% to 40% of the first length, inclusive. In some embodiments, the third length is equal to the second length.

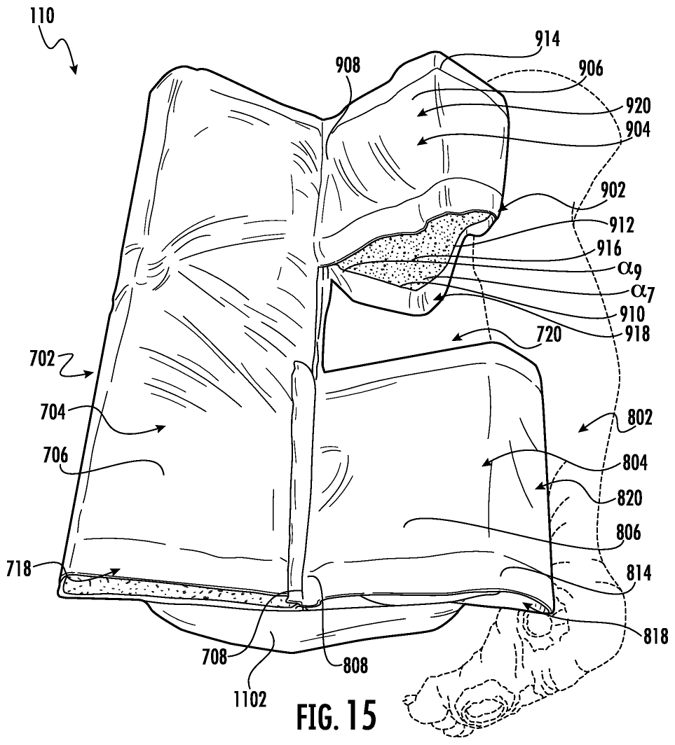

The second auxiliary support body 904 further includes a second auxiliary base wall 910. The second auxiliary base wall 910 is contiguous with the third edge 908. The second auxiliary support body 904 also includes a second auxiliary lateral wall 912. The second auxiliary lateral wall 912 is contiguous with the second auxiliary base wall 910. As seen in, for example, FIG. 15, the second auxiliary base wall 910 and the second auxiliary lateral wall 912 are separated by a seventh angle α₇. The seventh angle α₇ is between 70 degrees and 90 degrees, inclusive.

The second auxiliary support body 904 further includes a second auxiliary top wall 914. The second auxiliary top wall 914 is contiguous with the second auxiliary lateral wall 912 and the second auxiliary ramp surface 906. As seen in, for example, FIG. 16, the second auxiliary top wall 914 and the second auxiliary ramp surface 906 are separated by a eighth angle α₈. The eighth angle as is between 50 degrees and 90 degrees, inclusive. The second auxiliary ramp surface 906 and the second auxiliary base wall 910 are separated by a ninth angle α₉. The ninth angle α₉ is between 50 degrees and 80 degrees, inclusive.

The second auxiliary support body 904 further includes a second side surface 916. The second side surface 916 is contiguous with the second auxiliary ramp surface 906, the second auxiliary base wall 910, the second auxiliary lateral wall 912, and the second auxiliary top wall 914. The second side surface 916 faces the first side surface 816, and are separated by a fourth length. The fourth length is 20% to 40% of the first length, inclusive. In some embodiments, the fourth length is equal to the second length and the third length. In some embodiments, the second auxiliary ramp surface 906 is rounded and convex relative to the second auxiliary base wall 910 and the second auxiliary top wall 914.

The second auxiliary support 902 further includes a second auxiliary cover 918. The second auxiliary cover 918 extends around (e.g., covers) at least a portion of the second auxiliary support body 904. In various embodiments, the second auxiliary cover 918 covers the second auxiliary support body 904 (e.g., the second auxiliary cover 918 covers an entirety of the second auxiliary support body 904).

In some embodiments, the second auxiliary cover 918 is formed from a polymeric material. The polymeric material is non-absorbent (e.g., water repellant, cleanable). For example, the polymeric material is at least one of nylon, polyester, acrylic, olefin (polypropylene), vinyl-coated fabrics, PU-coated fabrics, elastane, microfiber, spacer material, etc. The second auxiliary cover 918 may be replaceable and/or washable. The second auxiliary cover 918 may include at least one fastener such as a zipper, buttons, hook-and-loop, laces, and/or clasps. The at least one fastener may facilitate replacing and/or washing the second auxiliary cover 918.

The second auxiliary cover 918 is hingedly coupled to the main cover 716 along the first edge 708 and the third edge 908 so that the second auxiliary support 902 is rotatable relative to the main support 702. The second auxiliary cover 918 is hingedly coupled to the main cover 716 via stitching. In some embodiments, the second auxiliary cover 918 is hingedly coupled to the main cover 716 via hinges, staples, adhesives, etc.

In various embodiments, the second auxiliary support 902 and the main support 702 are configured such that the second auxiliary support 902 is capable of rotating between 0 and 180 degrees, inclusive, relative to the main support 702. A hinged coupling along the first edge 708 and the third edge 908 allows the main ramp surface 706 and the second auxiliary ramp surface 906 to face upward (e.g., in contact with the body parts 106, facing opposite the top bed surface 108). For example, the hinged coupling allows for various configurations of the offloader system 110 with the main ramp surface 706 and the second auxiliary ramp surface 906 facing upwards in each of the various configurations. The hinged coupling of the second auxiliary support 902 and the first auxiliary support 802 to the main support 702 allows for further configurations of the offloader system 110.

The first auxiliary support 802 is located at a first location 820 along the first edge 708 and the second auxiliary support 902 is located at a second location 920 along the first edge 708. In this case, the first edge 708 also includes a third position 720 which is a gap (e.g., hole, space) between the first auxiliary support 802 and the second auxiliary support 902. The gap corresponds to the fourth length. The gap may be aligned with body parts 106 to enhance support and comfort of the patient 104. For example, the gap may be aligned (e.g., below) a sacrum of the patient 104, allowing the sacrum to be suspended above the top bed surface 108 (e.g., not in contact with the top bed surface 108).

In some embodiments, the first auxiliary support 802 is located at the third position 720. In this case, the first side surface 816 and the second side surface 916 are contiguous. In some embodiments, the second auxiliary support 902 is located at the third position 720. In this case, the first side surface 816 and the second side surface 916 are contiguous. In some embodiments, the first auxiliary support 802 and the second auxiliary support 902 are both located at the third position 720 (e.g., located at a midpoint of the first edge 708. In some embodiments, the offloader system 110 does not include the first auxiliary support 802. In some embodiments, the offloader system 110 does not include the second auxiliary support 902. In some embodiments, the offloader system does not include either the first auxiliary support 802 or the second auxiliary support 902.

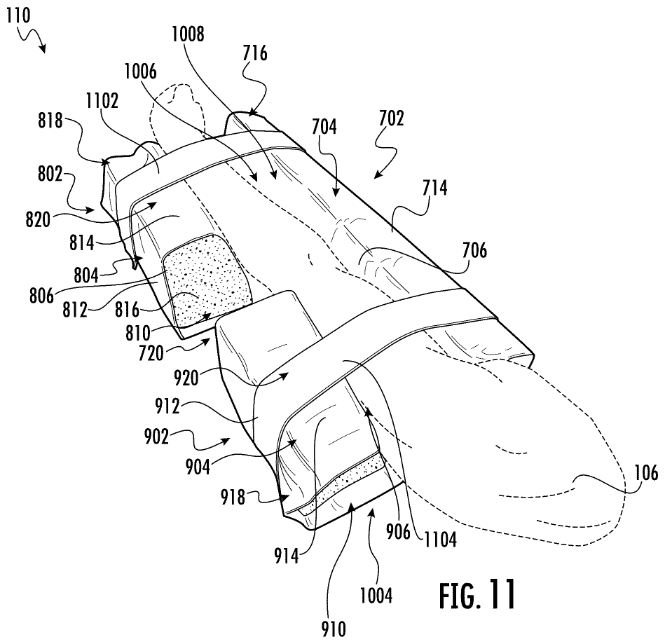

The offloader system 110 has a first position (e.g., one of the various configurations) as seen in, for example, FIGS. 10-14. The main base wall 710, the first auxiliary base wall 810, and the second auxiliary base wall 910 form a first base surface 1004. In some embodiments, the first base surface 1004 is in contact with the top bed surface 108 (e.g., the main base wall 710, the first auxiliary base wall 810, and the second auxiliary base wall 910 are in contact with the top bed surface 108). The main ramp surface 706, the first auxiliary ramp surface 806, and the second auxiliary ramp surface 906 form a first top surface 1006 defining a receptacle 1008. The receptacle 1008 faces opposite the first base surface 1004 and in some embodiments, is in contact with the body parts 106 of the patient 104. The receptacle 1008 receives and holds the body parts 106 as seen in, for example, FIG. 11. In the first position 1002, to define the receptacle 1008, the main ramp surface 706 faces the first auxiliary ramp surface 806 and the second auxiliary ramp surface 906.

The offloader system 110 also has a second position (e.g., one of the various configurations), as seen in, for example, FIG. 16. The second position is formed by rotating the first auxiliary support 802 and the second auxiliary support 902 via the first edge 708, the second edge 808, and the third edge 908. For example, the second position is formed by rotating the first auxiliary support 802 and the second auxiliary support 902 180 degrees relative to the first position 1002.

The main lateral wall 712, the first auxiliary lateral wall 812, and the second auxiliary lateral wall 912 form a second base surface 1012 in the second position. In some embodiments, the second base surface 1012 are in contact with the top bed surface 108 (e.g., the main lateral wall 712, the first auxiliary lateral wall 812, and the second auxiliary lateral wall 912 are in contact with the top bed surface 108). The main ramp surface 706, the first auxiliary ramp surface 806, and the second auxiliary ramp surface 906 form a second top surface 1014, facing opposite the second base surface 1012 (e.g., opposite the top bed surface 108). Furthermore, the first auxiliary base wall 810 and the second auxiliary base wall 910 are contiguous with the main base wall 710. The offloader system 110 is placed underneath various body parts 106. For example, the offloader system 110 is placed underneath a back of the patient 104 in the second position.

FIG. 15 depicts the offloader system 110 at a position between the first position 1002 and the second position 1010. In some embodiments, a height of the main lateral wall 712 is greater than a height of the first auxiliary lateral wall 812 and the second auxiliary lateral wall 912.

In some embodiments, the offloader system 110 further includes one or more straps. The offloader system 110 includes a first strap 1102 and a second strap 1104. The first strap 1102 is coupled to the main lateral wall 712 and the first auxiliary lateral wall 812. The first strap 1102 extends over the main top wall 714 and the first auxiliary top wall 814. The first strap 1102 is in contact with the main lateral wall 712, the first auxiliary lateral wall 812, the main top wall 714, and the first auxiliary top wall 814. The first strap 1102 provides additional securement of the body part 106 while the body part 106 is housed in, for example, the receptacle 1008.

In some embodiments, the first strap 1102 is detachably coupled to the main lateral wall 712 and the first auxiliary lateral wall 812. The first strap 1102 includes an elastic material. For example, the elastic material is at least one of elastic bands, elastane, nylon, rubber or mesh. In some embodiments, the first strap 1102 does not extend over the main top wall 714 and the first auxiliary top wall 814, while being coupled to the main lateral wall 712 and the first auxiliary lateral wall 812.

The second strap 1104 is coupled to the main lateral wall 712 and the second auxiliary lateral wall 912. The second strap 1104 extends over the main top wall 714 and the second auxiliary top wall 914. The second strap 1104 is in contact with the main lateral wall 712, the second auxiliary lateral wall 912, the main top wall 714, and the second auxiliary top wall 914. The second strap 1104 provides additional securement of the body part 106 while the body part 106 is housed in, for example, the receptacle 1008.

In some embodiments, the second strap 1104 is detachably coupled to the main lateral wall 712 and the second auxiliary lateral wall 912. The second strap 1104 includes an elastic material. For example, the elastic material is at least one of elastic bands, elastane, nylon, rubber or mesh. In some embodiments, the second strap 1104 does not extend over the main top wall 714 and the second auxiliary top wall 914, while being coupled to the main lateral wall 712 and the second auxiliary lateral wall 912.

In some embodiments, the offloader system 110 does not include the first strap 1102. In some embodiments, the offloader system 110 does not include the second strap 1104. In some embodiments, the offloader system 110 does not include the first strap 1102 or the second strap 1104.

### V. Overview of Third Example Offloader System

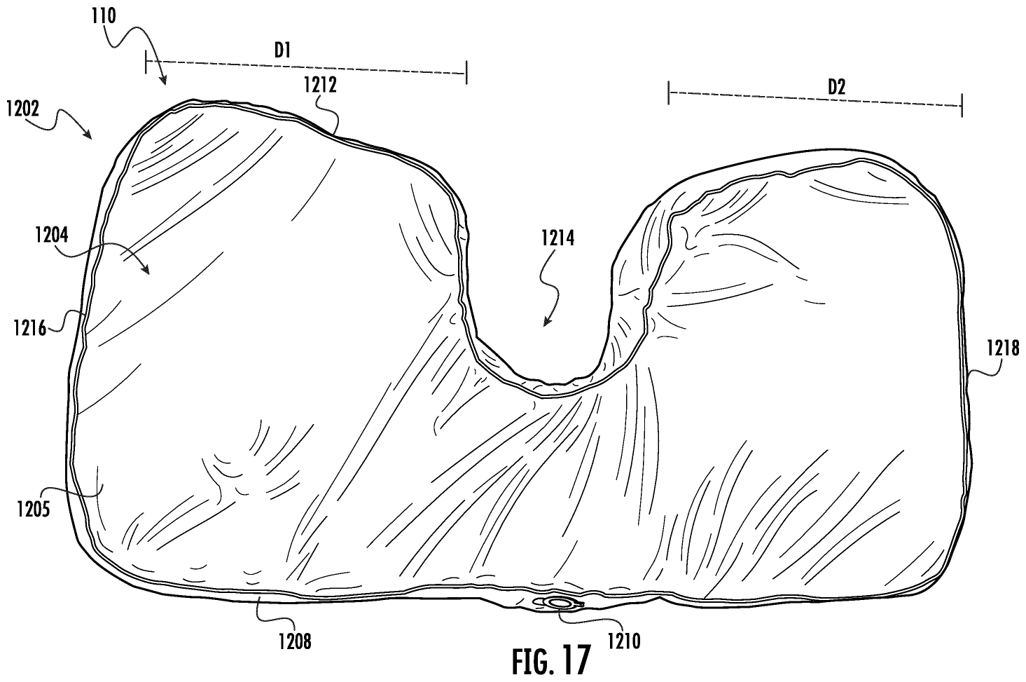

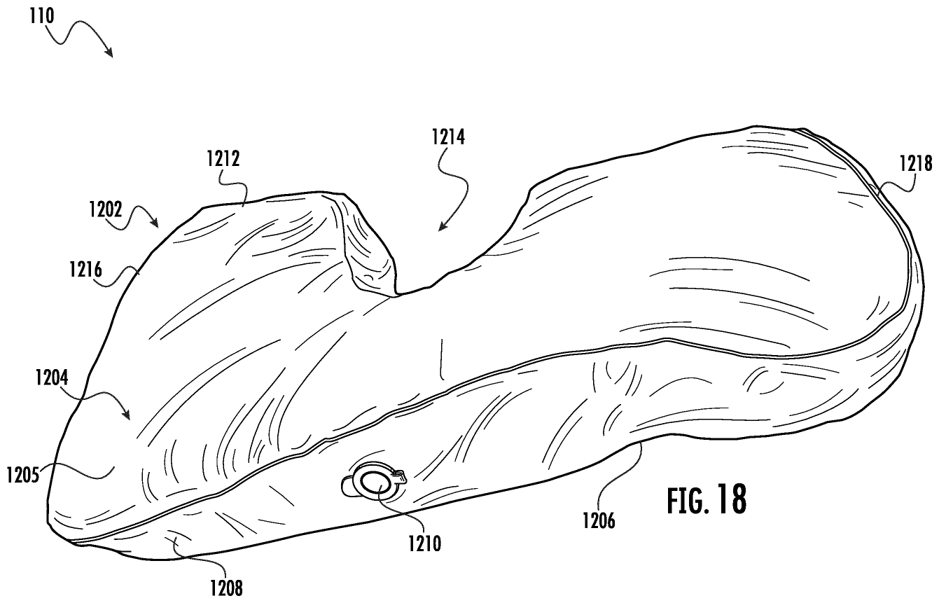

FIGS. 17-21 depict various views of another example offloader system 110, according to an embodiment. The offloader system 110 includes a main support 1202. The main support 1202 is configured to support the body parts 106. As an example, the main support 1202 reduces pressure on the body parts 106 by placing the main support 1202 underneath the body parts 106. The main support 1202 is configured to assist clinicians with turning and positioning procedures. As an example, the main support 1202 adjusts an orientation of the patient without physical burden of the clinician during inflation of the device.

The main support 1202 includes a main support body 1204. The main support body 1204 is inflatable such that the main support body 1204 may hold a fluid during usage of the offloader system 110. The main support body 1204 is configured to be placed between a patient 104 and a support surface (e.g., bed 102, hospital chair, wheelchair) prior to inflation (e.g., when in a deflated state). The main support body 1204 includes a first sheet 1205 and a second sheet 1206. The first sheet 1205 is configured to receive (e.g., contact, support, offload) the body parts 106. The second sheet 1206 is positioned opposite of the first sheet 1205. The second sheet 1206 is configured to receive a top surface of a support surface. The first sheet 1205 overlaps and cooperates with the second sheet 1206 to form a cover. The cover is configured to enclose the internal components of the main support body 1204 and hold a fluid, forming an inflatable cushion assembly.

In various embodiments, the first sheet 1205 and the second sheet 1206 are formed of a polymeric material. The polymeric material is non-absorbent (e.g., water repellant, cleanable). As an example, the polymeric material may be polyvinyl chloride (PVC), thermoplastic polyurethane (TPU), polyethylene (PE), non-woven polypropylene, polyurethane-coated fabrics, nylon, or various other medical grade materials. In some applications, the first sheet 1205 and the second sheet 1206 may be formed of different polymeric materials. In other applications, a portion of the first sheet 1205 and/or the second sheet 1206 may feature a coating (e.g., a polyurethane (PU), TPU, or PVC coating) to increase the coefficient of friction of the polymeric material. In other applications, the first sheet 1205 and the second sheet 1206 may be formed of different polymeric materials.

The first sheet 1205 and the second sheet 1206 may be formed in similar shapes (e.g., geometrically similar shapes). As an example, the first sheet 1205 and the second sheet 1206 may be formed in a contoured shape configured to receive a respective body part 106. As another example, the first sheet 1205 and the second sheet 1206 may be formed in a rounded rectangle. In some applications, the first sheet 1205 and the second sheet 1206 may be formed in a square, a rectangle, a circle, an oval, a polygon, or various other shapes. In some embodiments, the first sheet 1205 is identical to the second sheet 1206. In these embodiments, the first sheet 1205 perfectly overlap and cooperates with the second sheet 1206 to form the main support 1202.

As shown in FIGS. 17-21, the main support body 1204 includes formed regions (e.g., edges, periphery of main support 1202). The formed regions define the first sheet 1205 and the second sheet 1206. The formed regions may include a first edge 1208, a second edge 1212, a first side edge 1216, and a second side edge 1218. The formed regions may include sealing materials such as thermoplastic polymers, rubber, adhesives, welded seams, and/or various other materials. In some embodiments, the formed regions are manufactured by heat sealing, radio frequency (RF) welding, ultrasonic welding, adhesive sealing, and/or various other processes.

The formed region includes a first edge 1208. The first sheet 1205 and the second sheet 1206 are coupled at the first edge 1208 to enclose the internal components of the main support body 1204. The first edge 1208 includes a valve 1210 positioned along the first edge 1208. The valve 1210 is coupled to the first sheet 1205 and the second sheet 1206. The valve 1210 is in fluid communication with the main support body 1204 and is configured to facilitate entrance of fluid into the main support body 1204. In some embodiments, the fluid is a gas. For example, the fluid may be or include atmospheric air, medical grade air, nitrogen, carbon dioxide, or other similar gases.

In some embodiments, the valve 1210 is a one-way valve (e.g., check valve). In these embodiments, the valve 1210 is configured to allow a flow of fluid into the main support body 1204 while preventing exit of the fluid during operation. In these embodiments, the main support body 1204 includes a pressure-relief valve (not shown) that is coupled to the first edge 1208 and valve 1210. The pressure-relief valve is configured to open and release the fluid when a pressure of the fluid within the main support body 1204 is at a target pressure of the main support body 1204. In this way, the pressure-relief valve protects the main support body 1204 (e.g., against undesirable over pressurization). Additionally, the pressure-relief valve may facilitate selective release of the fluid within the main support body 1204 to tailor a pressure of the fluid within the main support body 1204 to a target pressure such that the main support body 1204 is tailored for a target application. As an example, after inflating the main support body 1204, a nurse may manipulate the pressure-relief valve to release some of the fluid such that the main support body 1204 is tailored for a target application.

In some embodiments, the valve 1210 is a two-way valve (e.g., inflation/deflation valve). In these embodiments, the valve 1210 is configured to be opened to allow the fluid to enter the main support body 1204 during inflation and exit the main support body 1204 during deflation. As an example, the valve 1210 may have two modes, in which a first mode comprises an inflation position and a second mode comprises a deflation position. A user may transition the valve 1210 from a first mode to a second mode by engaging with the valve 1210 (e.g., twisting, pushing, pulling, or removing a cap) to allow a flow of fluid out of the main support body 1204.

The formed regions include a second edge 1212. The first sheet 1205 and the second sheet 1206 are coupled at the second edge 1212 to enclose the internal components of the main support body 1204. The second edge 1212 includes a concave portion 1214. The concave portion 1214 includes symmetrical, concave indentation (e.g., “U” shape). The concave portion 1214 is separated from the first side edge 1216 by a first distance D1 and the second side edge 1218 by a second distance D2. In some embodiments, the concave portion 1214 is positioned at a location on the second edge 1212 equidistant from the first side edge 1216 and the second side edge 1218 (e.g., D1 and D2 are equal). In some applications, the concave portion 1214 may be positioned at a location on the second edge 1212 substantially closer to the first side edge 1216 than the second side edge 1218 (e.g., D1 is less than D2). In other applications, the concave portion 1214 may be positioned at a location on the second edge 1212 substantially closer to the second side edge 1218 than the first side edge 1216 (e.g., D1 is greater than D2). The concave portion 1214 is configured to receive the body parts 106. As an example, the concave portion 1214 may support a sacrum (e.g., tailbone) of the patient.

The formed regions may include a first side edge 1216 and a second side edge 1218. The first sheet 1205 and the second sheet 1206 are coupled at the first side edge 1216 and the second side edge 1218 to enclose the internal components of the main support body 1204. The length of first side edge 1216 and the length of the second side edge 1218 are 40% to 60% of the length of first edge 1208, inclusive. As an example, the length of the first edge 1208 may be about 29 inches and the length of the first side edge 1216 and the second side edge 1218 may be about 16 inches. In some applications, the valve 1210 may be positioned along either the first side edge 1216 or the second side edge 1218, thereby facilitating entrance of fluid into the main support body 1204.

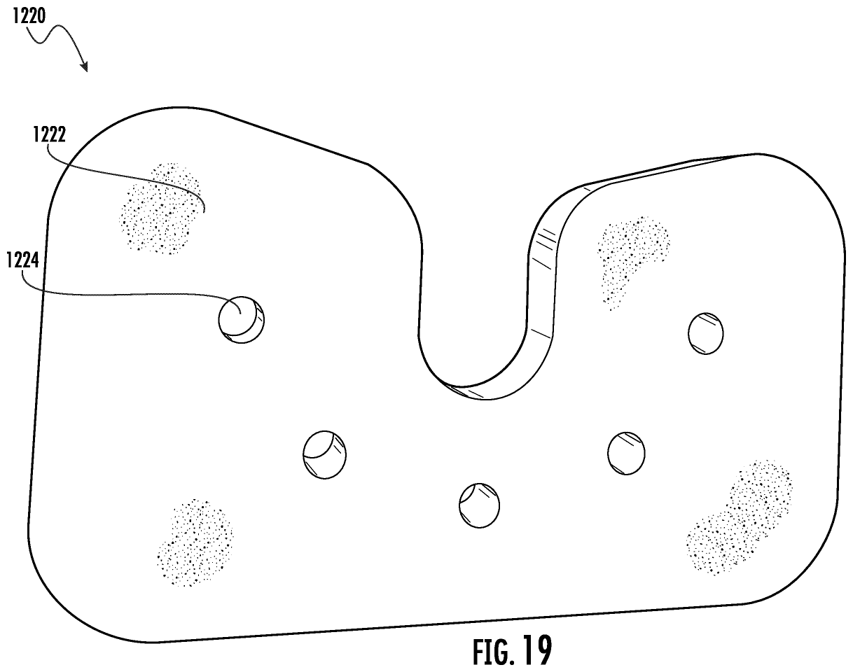

As shown in FIG. 19, the main support body 1204 includes an inner core 1220. The inner core 1220 includes a first core face 1222 and a second insert face (not shown). The first core face 1222 is configured to face an interior face of the first sheet 1205. The second core face is positioned opposite the first core face 1222. The second core face is configured to face an interior face of the second sheet 1206.

In some embodiments, the inner core 1220 is formed of a compressible material. As an example, the compressible material may be gel, open-cell polyurethane foam, viscoelastic foam, spacer mesh, or various other medical grade materials. The compressible material is configured to provide structural integrity and improve leverage of a patient as the main support body 1204 is positioned to support the body parts 106. In some applications, the inner core 1220 may be formed of different compressible materials. As an example, the inner core 1220 may be formed of hybrid closed cell foam to allow for mild immersion into the main support body 1204 while supporting the patient.

In some embodiments, the inner core 1220 is a similar shape as the first sheet 1205 and the second sheet 1206, such that the inner core 1220 is enclosed in the main support body 1204. As an example, the inner core 1220 may have a similar contoured shape as the first sheet 1205 and the second sheet 1206. As another example, the inner core 1220 may have a similar rectangular shape as the first sheet 1205 and the second sheet 1206.

The inner core 1220 includes a plurality of apertures 1224. The apertures 1224 extend from the first core face 1222 to the second core face. The apertures 1224 are positioned proximate to the concave portion 1214. As an example, the apertures 1224 are positioned radially about the concave portion 1214. In some applications, the inner core 1220 includes between one to ten of the apertures 1224. As an example, the inner core 1220 includes five of the apertures 1224, as shown in FIG. 19. In other applications, the inner core 1220 may include any number of the apertures 1224 positioned about the inner core 1220. The apertures 1224 is configured to allow for spot welds to stabilize the first sheet 1205 and the second sheet 1206 within each respective aperture. As a result, the spot welds may control the shape of the main support body 1204 during inflation. The apertures 1224 is configured to guide placement of body parts 106 with high-pressure risk on the main support body 1204. As an example, the apertures 1224 may assist in the placement of body parts 106 with boney prominences such as the sacrum, elbows, heels, and back of the head.

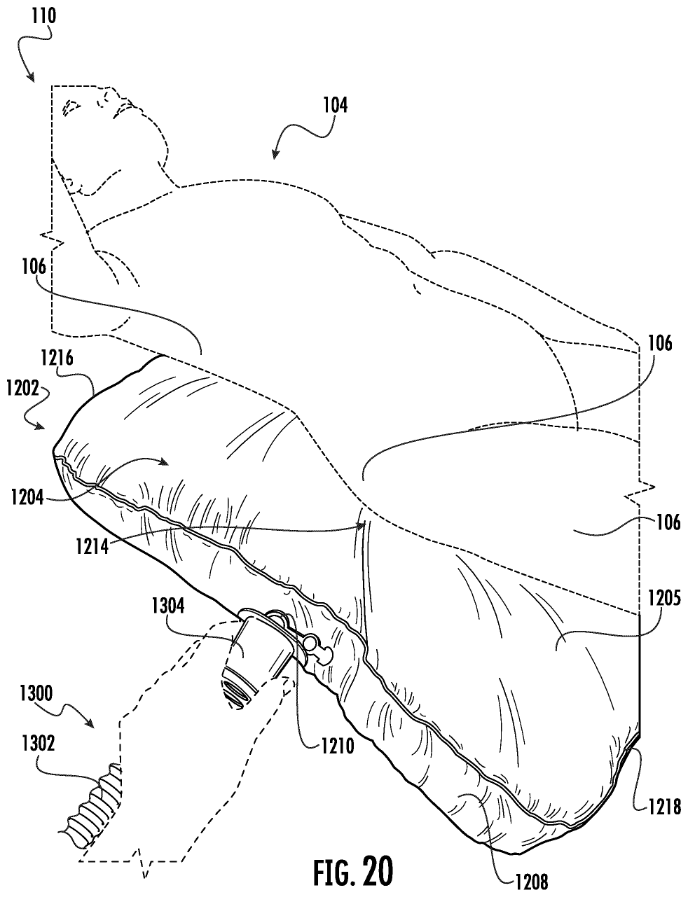

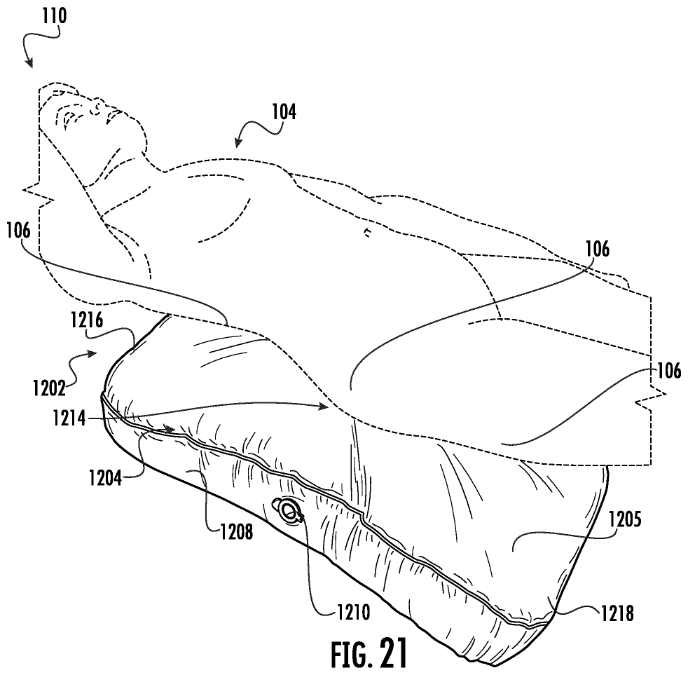

As shown in FIGS. 20 and 21, the offloader system 110 includes an external pump 1300. In some embodiments, the external pump 1300 is powered via a battery or an electrical outlet. The external pump 1300 includes a pump tube 1302, a connector 1304, a motor (not shown), and a pump system (not shown). The connector 1304 is positioned at a distal end of the pump tube 1302. The connector 1304 is configured to engage with the valve 1210 to create an air-tight seal during inflation of the main support body 1204. In some embodiments, after the main support body 1204 is positioned underneath a body part 106, the connector 1304 may be placed on the valve 1210 and facilitate the flow of fluid into the main support body 1204 via the motor and pump system. As the main support body 1204 fills with air, the main support body 1204 begins to offload and turn the patient 104 towards a desired side of the support surface.

### VI. Overview of Fourth Example Offloader System

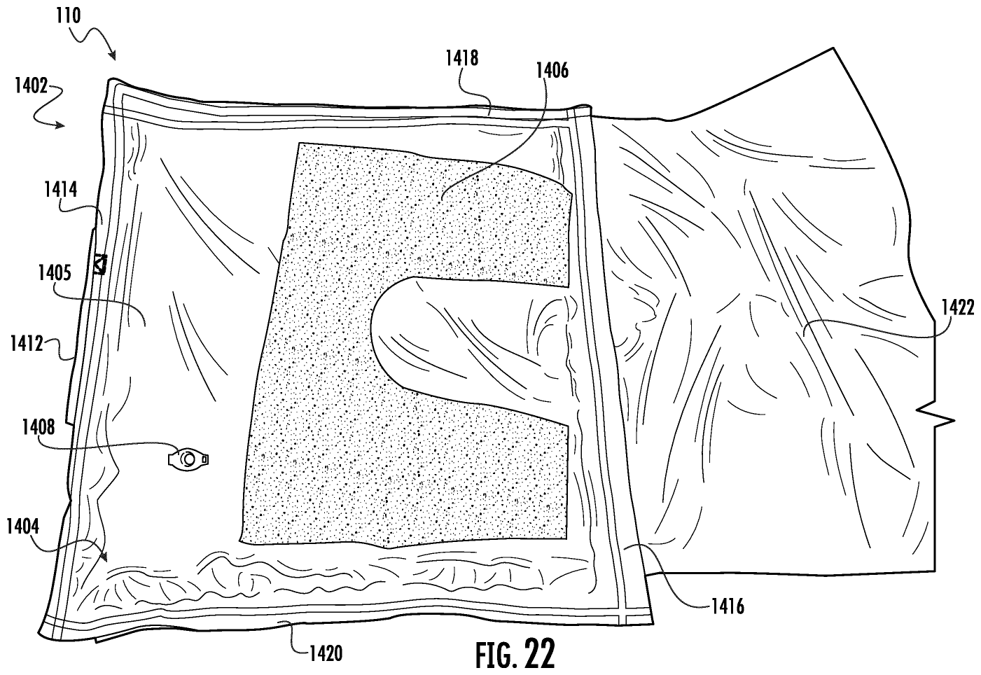

FIGS. 22-25 depict various views of another example offloader system 110, according to an embodiment. The offloader system 110 includes a main support 1402. The main support 1402 is configured to support the body parts 106. As an example, the main support 1402 reduces pressure on the body parts 106 by placing the main support 1402 underneath the body parts 106. The main support 1402 is configured to assist clinicians with turning and positioning procedures. As an example, the main support 1402 adjusts an orientation of the patient without physical burden of the clinician during inflation of the device.

The main support 1402 includes a main support body 1404. Similarly to the embodiments of FIGS. 17-21, the main support body 1404 is inflatable such that the main support body 1404 may hold a fluid during usage of the offloader system 110. The main support body 1404 is configured to be placed between a patient and a support surface (e.g., bed 102, hospital chair, wheelchair) prior to inflation (e.g., when in a deflated state).

The main support body 1404 includes a first sheet 1405. The first sheet 1405 is configured to receive (e.g., contact, support, offload) the body parts 106. The first sheet 1405 includes a first polymeric material with a first coefficient of friction. The first polymeric material is non-absorbent (e.g., water repellant, cleanable). As an example, the first polymeric material may be polyvinyl chloride (PVC), thermoplastic polyurethane (TPU), polyethylene (PE), non-woven polypropylene, polyurethane-coated fabrics, nylon, or various other medical grade materials.

As shown in FIGS. 22, 24, and 25, the first sheet 1405 may include a retention region 1406 (e.g., retention layer, retention material, retention strip). The retention region 1406 is coupled to the first sheet 1405. In various embodiments, the retention region 1406 is coupled to the first sheet 1405 such that when a portion of the patient 104 is placed on the first sheet 1405, the portion of the patient 104 is placed on the retention region 1406. The retention region 1406 is configured to restrict (e.g., resist, impede, slow) vertical shifting of a patient placed on the retention region 1406 (e.g., movement of the patient placed on the retention region 1406 in a first direction) while facilitating unrestricted movement of the main support 1402 relative to the support surface. The retention region 1406 is configured to restrict (e.g., resist, impede, slow) leftward or rightward movement (e.g., horizontal shifting) of a patient placed on the retention region 1406 (e.g., movement of the patient placed on the retention region 1406 in a second direction) while facilitating unrestricted movement of the main support 1402 relative to the support surface.

The retention region 1406 includes a different material than the first sheet 1405. The retention region 1406 includes a second polymeric material with a second coefficient of friction. The second coefficient of friction is greater than the first coefficient of friction. As an example, the second polymeric material may be polyester, nylon, foam, rubberized materials, silicone-infused fabrics, cotton, or other similar materials. In some embodiments, the retention region 1406 may include, for example, a coating (e.g., a PU, TPU, or PVC coating) to provide the second coefficient of friction.

The first sheet 1405 and the retention region 1406 may be formed of different shapes (e.g., geometrically different shapes). As an example, the first sheet 1405 may be a rounded rectangle, while the retention region 1406 may be a contoured shape configured to receive a respective body part 106. In some embodiments, the first sheet 1405 and the retention region 1406 may be formed of similar shapes (e.g., geometrically similar shapes). As an example, the first sheet 1405 and the retention region 1406 may be formed in a contoured shape configured to receive a respective body part 106. As another example, the first sheet 1405 and the retention region 1406 may be formed in a rounded rectangle. In some applications, the first sheet 1405 and the second sheet 1410 may be formed in a square, a rectangle, a circle, an oval, a polygon, or various other shapes.

The first sheet 1405 includes a valve 1408. The valve 1408 is coupled to the first sheet 1405. As an example, the valve 1408 may be positioned proximate to a periphery of the first sheet 1405. The valve 1408 is in fluid communication with the main support body 1404 and is configured to facilitate entrance of fluid into the main support body 1404. In some embodiments, the fluid is a gas. As an example, the fluid may include gases such as atmospheric air, medical grade air, nitrogen, carbon dioxide, or other similar gases.

In some embodiments, the valve 1408 is a one-way valve (e.g., check valve). The valve 1408 is configured to allow a flow of fluid into the main support body 1404 while preventing exit of the fluid during operation. In these embodiments, the main support body 1404 includes a pressure-relief valve (not shown) that is coupled to the first sheet 1405 and valve 1408. The pressure-relief valve is configured to open and release the fluid when a pressure of the fluid within the main support body 1404 is at a target pressure of the main support body 1404. In this way, the pressure-relief valve protects the main support body 1404 (e.g., against undesirable over pressurization). Additionally, the pressure-relief valve may facilitate selective release of the fluid within the main support body 1404 to tailor a pressure of the fluid within the main support body 1404 to a target pressure such that the main support body 1404 is tailored for a target application. As an example, after inflating the main support body 1404, a nurse may manipulate the pressure-relief valve to release some of the fluid such that the main support body 1404 is tailored for a target application.

In some embodiments, the valve 1408 is a two-way valve (e.g., inflation/deflation valve). The valve 1408 is configured to be opened to allow the fluid to enter the main support body 1404 during inflation and exit the main support body 1404 during deflation. As an example, the valve 1408 may have two modes, in which a first mode comprises an inflation position and a second mode comprises a deflation position. A user may transition the valve 1408 from a first mode to a second mode by engaging with the valve 1408 (e.g., twisting, pushing, pulling, or removing a cap) to allow a flow of fluid out of the main support body 1404.

The main support body 1404 includes a second sheet 1410. The second sheet 1410 is positioned opposite of the first sheet 1405. The second sheet 1410 is configured to receive a top surface of a support surface. The first sheet 1405 is coupled to the second sheet 1410 to form a cover. The cover is configured to enclose the internal components of the main support 1402, forming an inflatable cushion assembly capable of holding a fluid. The second sheet 1410 includes the same material has the first sheet 1405 (e.g., the first polymeric material with a first coefficient of friction). In other applications, the first sheet 1405 and the second sheet 1410 may be formed of different polymeric materials. In some embodiments, the first sheet 1405 and the second sheet 1410 may be formed of similar shapes (e.g., geometrically similar shapes). In some embodiments, the shape of the first sheet 1405 is identical to the shape of the second sheet 1410. In these embodiments, the first sheet 1405 perfectly overlaps and cooperates with the second sheet 1410 to form the main support 1402.

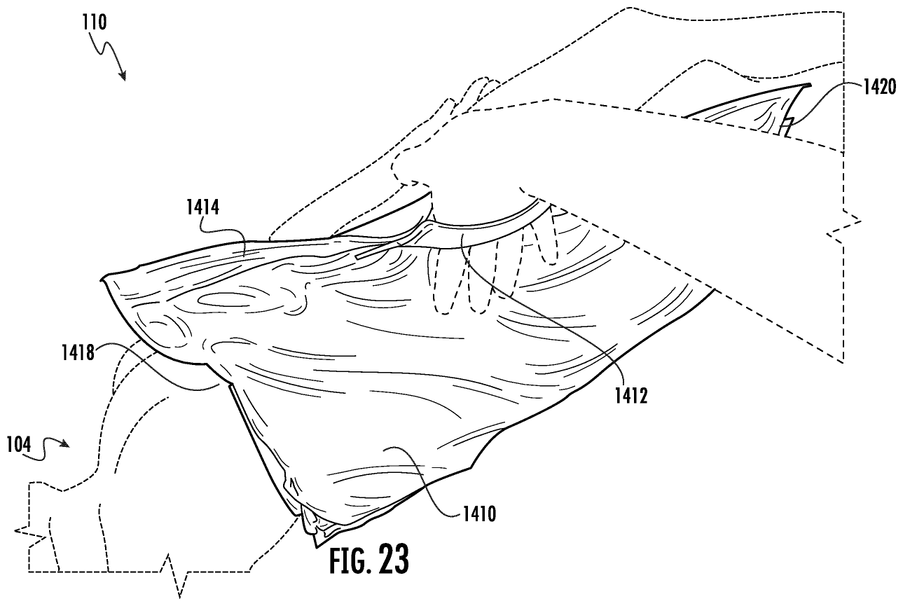

As shown in FIGS. 23-25, the second sheet 1410 includes a handle 1412. The handle 1412 is coupled to the second sheet 1410 and positioned adjacent to an edge of the main support body 1404. As an example, the handle 1412 is positioned adjacent to a first edge 1414. As another example, the handle 1412 may be positioned at a central portion of the second sheet 1410, where the handle 1412 is equidistant from each side edge. The handle 1412 may be stitched, glued, welded, or otherwise fastened to the second sheet 1410. The handle 1412 is configured to facilitate movement of the main support 1402 relative to the patient 104 and/or the support surface. The handle 1412 is configured to facilitate placement of the main support 1402 using at least one hand, where a clinician can secure the main support body 1404 with a first hand and perform an additional task with a second hand.

As shown in FIGS. 22-25, the main support body 1404 includes formed regions (e.g., edges, periphery of main support 1402). The formed regions define the first sheet 1405 and the second sheet 1410. The formed regions include a first edge 1414, a second edge 1416, a first side edge 1418, and a second side edge 1420. In some embodiments, the length of first side edge 1418 and the length of the second side edge 1420 are 40% to 60% of the length of first edge 1414, inclusive. As an example, the length of the first edge 1414 may be about 29 inches and the length of the first side edge 1418 and the second side edge 1420 may be about 16 inches The formed regions the internal components of the main support body 1404 such as the inner core (not shown). The formed regions may include sealing materials such as thermoplastic polymers, rubber, adhesives, welded seams, and/or various other materials. In some embodiments, the formed regions are manufactured by heat sealing, radio frequency (RF) welding, ultrasonic welding, adhesive sealing, and/or various other processes.

The main support body 1404 includes an inner core (not shown). The configuration of the inner core may be similar to the configuration of the inner core 1220 of FIG. 19.

As shown in FIG. 22, the main support 1402 includes a tail 1422. The tail 1422 extends from the second edge 1416. The tail 1422 includes the same material has the first sheet 1405 (e.g., the first polymeric material with a first coefficient of friction). In some embodiments, the tail 1422 has a substantially rectangular shape. In other applications, the tail 1422 may be formed in a square, a rectangle, a circle, an oval, a polygon, or various other shapes to accommodate the shape of the main support body 1404. In some embodiments, the tail 1422 is configured to initially cover the retention region 1406 during placement of the main support 1402 relative to the patient 104, thereby reducing friction. The tail 1422 may then be pulled (e.g., engaged with) from a second location opposite of the placement location, thereby exposing the retention region 1406 to engage with the patient 104. As an example, a clinician may initially place the main support 1402 on a leftmost side of a patient 104 and pull the tail 1422 from the rightmost side of the patient 104, thereby exposing the retention region 1406. The clinician may stabilize the main support body 1404 via the handle 1412 with a first hand and pull the tail 1422 with a second hand.

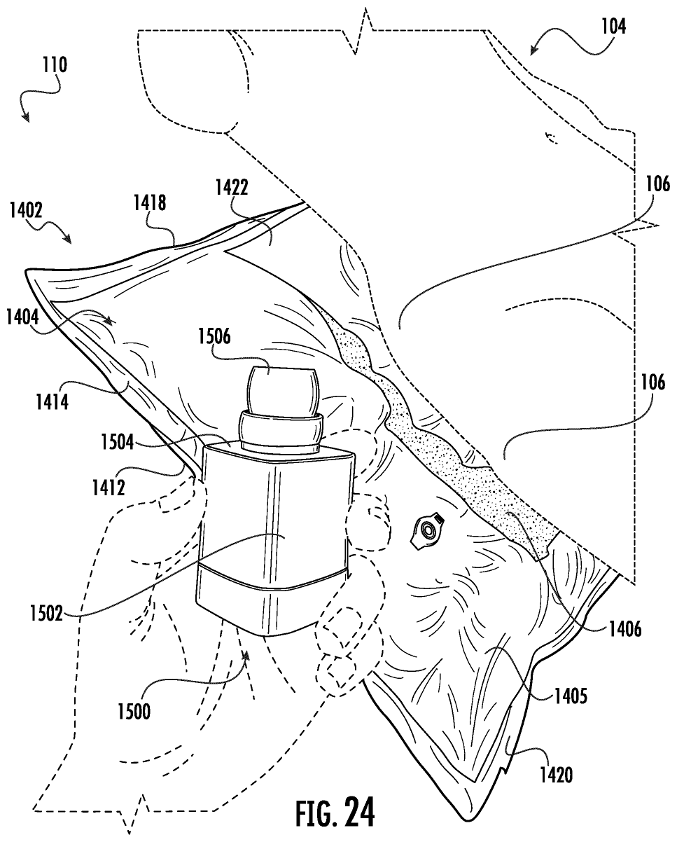

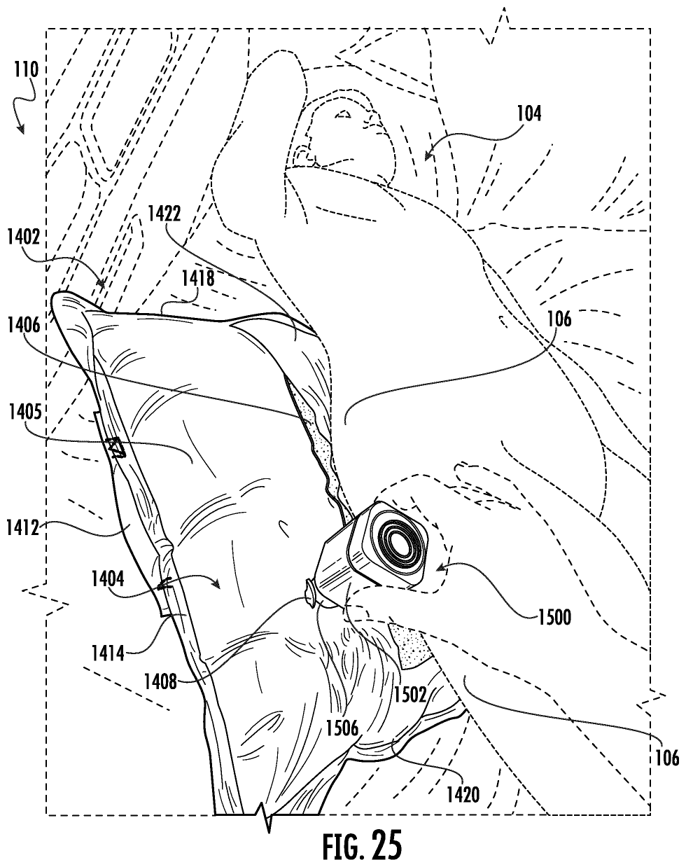

The offloader system 110 includes an air pump. The air pump may include the external pump 1300. As shown in FIGS. 24 and 25, the pump system may include a portable air pump system 1500. The portable air pump system 1500 includes a base 1502. The base includes a blower top face 1504 with an adapter 1506, a motor (not shown), and a pump system (not shown). The adapter 1506 is configured to engage with the valve 1408 to create an air-tight seal during inflation of the main support body 1404. In some embodiments, after the main support body 1404 is positioned underneath a body part 106, the adapter 1506 may be placed on the first edge 1208 and facilitate the flow of fluid into the main support body 1404 via the motor and the pump system. As the main support body 1404 fills with air, the main support body 1404 begins to offload and turn the patient 104 towards a desired side of the support surface.

### VII. Overview of Fifth Example Offloader System

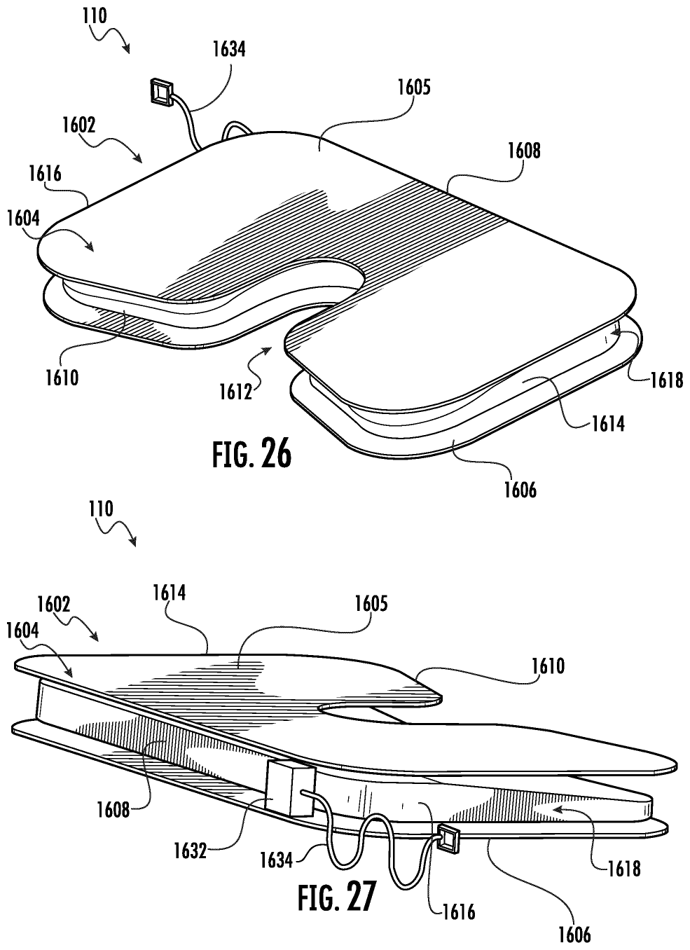

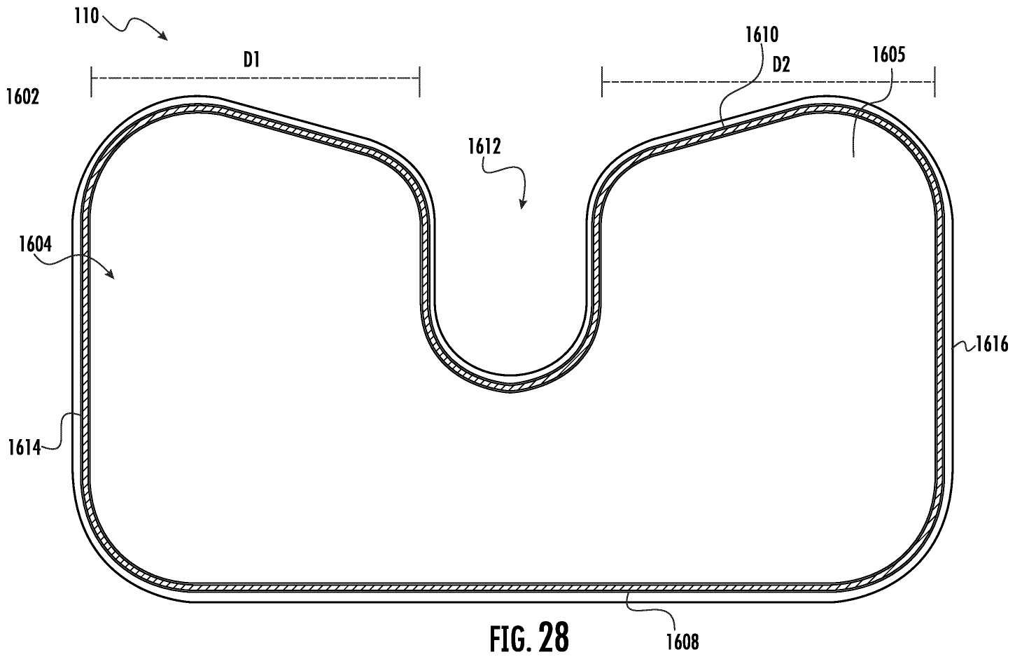

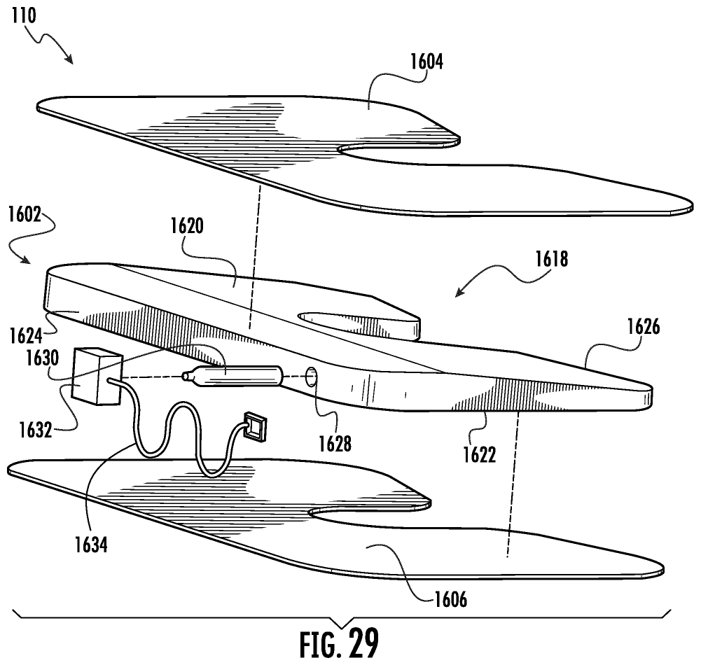

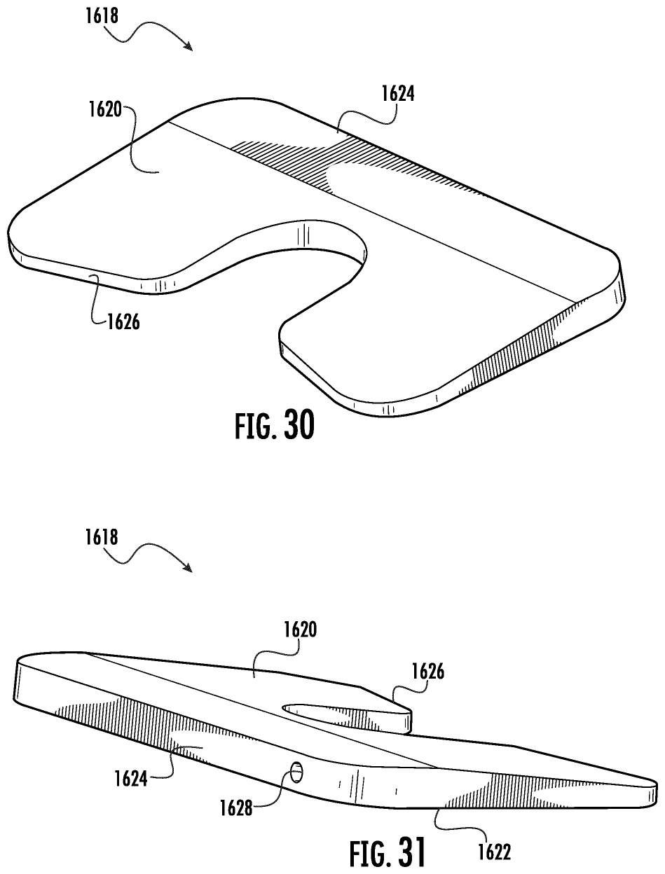

FIGS. 26-31 depict various views of another example offloader system 110, according to an embodiment. The offloader system 110 includes a main support 1602. The main support 1602 is configured to support the body parts 106. As an example, the main support 1602 reduces pressure on the body parts 106 by placing the main support 1602 underneath the body parts 106. The main support 1602 is configured to assist clinicians with turning and positioning procedures. As an example, the main support 1602 adjusts an orientation of the patient without physical burden of the clinician during inflation of the device.

The main support 1602 includes a main support body 1604. Similarly to the embodiments of FIGS. 17-25, the main support body 1404 is inflatable such that the main support body 1604 may hold a fluid during usage of the offloader system 110. The main support body 1604 is configured to be placed between a patient and a support surface (e.g., bed 102, hospital chair, wheelchair) prior to inflation (e.g., when in a deflated state). However, unlike the embodiments of FIGS. 17-25, the main support 1602 is self-inflatable, such that an external pump is no longer necessary for inflation.

The main support body 1604 includes a first layer 1605 (e.g., top film, first sheet) and a second layer 1606 (e.g., bottom film, bottom sheet). The first layer 1605 is configured to receive (e.g., contact, support, offload) the body parts 106. The second layer 1606 is positioned opposite of the first layer 1605. The second layer 1606 is configured to receive a top surface of a support surface.

The first layer 1605 and the second layer 1606 are formed of a polymeric material. The polymeric material is non-absorbent (e.g., water repellant, cleanable). As an example, the polymeric material may be polyvinyl chloride (PVC), thermoplastic polyurethane (TPU), polyethylene (PE), non-woven polypropylene, polyurethane-coated fabrics, nylon, or various other medical grade materials. In some applications, the first layer 1605 and second layer 1606 may be formed of different polymeric materials. In some applications, a portion of the first layer 1605 and/or the second layer 1606 may feature a coating (e.g., a polyurethane (PU), TPU, or PVC coating) to increase the coefficient of friction of the polymeric material. In other applications, the first layer 1605 and the second layer 1606 may be formed of different polymeric materials.

The main support body 1604 includes a first edge 1608 and a second edge 1610. The first edge 1608 has a substantially flat profile. The second edge 1610 is positioned opposite the first edge 1608. The second edge 1610 includes a concave portion 1612. The concave portion 1612 includes symmetrical, concave indentation (e.g., “U” shape). The concave portion 1612 is separated from a first side edge 1614 by a first distance D1 and the second side edge 1616 by a second distance D2. In some embodiments, the concave portion 1612 is positioned at a location on the second edge 1610 equidistant from the first side edge 1614 and the second side edge 1616 (e.g., D1 and D2 are equal). In some applications, the concave portion 1612 may be positioned at a location on the second edge 1610 substantially closer to the first side edge 1614 than the second side edge 1616 (e.g., D1 is less than D2). In other applications, the concave portion 1612 may be positioned at a location on the second edge 1610 substantially closer to the second side edge 1616 than the first side edge 1614 (e.g., D1 is greater than D2). The concave portion 1612 is configured to receive the body parts 106. As an example, the concave portion 1612 may support a sacrum (e.g., tailbone) of the patient. In some applications, the second edge 1610 may be sloped on either side of the concave portion 1612.

The main support body 1604 includes a first side edge 1614 and a second side edge 1616. In some embodiments, the first side edge 1614 and the second side edge 1616 have a substantially flat profile. In some embodiments, the length of first side edge 1614 and the length of the second side edge 1616 are 40% to 60% of the length of first edge 1608, inclusive. As an example, the length of the first edge 1608 may be about 29 inches and the length of the first side edge 1614 and the second side edge 1616 may be about 16 inches.

The main support body 1604 includes an inner core 1618. The inner core 1618 includes a first insert face 1620 and a second insert face 1622. The first insert face 1620 is configured to face an interior face of the first layer 1605. The second insert face 1622 is positioned opposite the first insert face 1620. The second insert face 1622 is configured to face an interior face of the second layer 1606. The first layer 1605 and the second layer 1606 is defined by a first insert edge 1624 and a second insert edge 1626. In some applications, the first insert edge 1624 and the second insert edge 1626 have a similar contour (e.g., shape, pattern). As an example, the first insert edge 1624 and the second insert edge 1626 have a substantially flat profile. In other applications, the first insert edge 1624 and the second insert edge 1626 have different contours.

In some embodiments, the inner core 1618 is formed of a compressible material. As an example, the compressible material may be gel, foam (e.g., open-cell polyurethane foam, viscoelastic foam), spacer mesh, or various other medical grade materials. The compressible material is configured to provide structural integrity and improve leverage of a patient as the main support body 1604 is positioned to support the body parts 106. In some applications, the inner core 1618 may be formed of different compressible materials. As an example, the inner core 1618 may be formed of hybrid closed cell foam to allow for moderate immersion into the inner core 1618 while supporting the patient.

The first layer 1605, the second layer 1606, and the inner core 1618 may be formed in similar shapes (e.g., geometrically similar shapes). As an example, the first layer 1605, the second layer 1606, and the inner core 1618 may be formed in a contoured shape configured to receive a respective body part 106. The contoured shape may be a similar shape to the embodiments of FIGS. 17-21. As another example, the first layer 1605, the second layer 1606, and the inner core 1618 may be formed in a rounded rectangle. In some applications, the first layer 1605, the second layer 1606, and the inner core 1618 may be formed in a square, a rectangle, a circle, an oval, a polygon, or various other shapes. In some embodiments, the first layer 1605, the second layer 1606, and the inner core 1618 are identical to one another. In these embodiments, the first layer 1605 perfectly overlaps and cooperates with the second layer 1606 to enclose the inner core 1618, forming a cover. The cover is configured to enclose the internal components of the main support 1602, forming an inflatable cushion assembly capable of holding a fluid. The first layer 1605 and the second layer 1606 may cooperate with one another along the first edge 1608, the second edge 1610, the first side edge 1614, and the second side edge 1616 to form the cover. As an example, the first layer 1605 and the second layer 1606 may cooperate with one another via a sealing material such as thermoplastic polymers, rubber, adhesives, welded seams, and/or various other materials. In some embodiments, the first layer 1605 and the second layer 1606 may cooperate with one another via a manufacturing process such as heat sealing, radio frequency (RF) welding, ultrasonic welding, adhesive sealing, and/or various other processes. In some embodiments, the first layer 1605 and the second layer 1606 have a greater surface area than the inner core 1618. In these embodiments, the first layer 1605 and the second layer 1606 extend past the inner core 1618 by a distance.

The inner core 1618 includes an aperture 1628 positioned along the first insert edge 1624. The first insert edge 1624 is positioned adjacent to the first edge 1608 of the main support 1602. As an example, when the main support 1602 is in an inflated or deflated state, the first insert edge 1624 is aligned with the first edge 1608 as the inner core 1618 is positioned in an interior of the main support body 1604. In some embodiments, the aperture 1628 is positioned adjacent to the first side edge 1614 or the second side edge 1616.

The main support 1602 includes a cartridge 1630. The cartridge 1630 holds a fluid, where the fluid is a gas. As an example, the fluid may include gases such as atmospheric air, medical grade air, nitrogen, carbon dioxide, or other similar gases. In some embodiments, the cartridge 1630 may be replaced or refilled via an air compressor to reuse the main support 1602 after inflation/deflation. The aperture 1628 is configured to receive an end of a cartridge 1630. As an example, the aperture 1628 may include one or more stabilizing features such as a notch, a flange, a silicone grommet, a clip, an elastic strap, or similar structure to hold the cartridge 1630 in place. The cartridge 1630 is configured to release the fluid into an interior of the main support 1602 via an engagement of the cartridge 1630. As an example, the cartridge 1630 may release the fluid via applying a force to the cartridge 1630 via an engagement with a release valve 1632. The engagement may include pull the cord 1634 to activate the release valve 1632. In some applications, the release valve 1632 may breach a barrier positioned at an end of the cartridge 1630, thereby allowing the release of fluid into the main support 1602. In other applications, the release valve 1632 may engage with a cap positioned at an end of the cartridge 1630 (e.g., twist, pull, push, press), thereby allowing the release of fluid into the main support 1602. In some embodiments, the release valve 1632 may be configured to release fluid from the main support body 1604 when a pressure of the fluid within the main support body 1604 is at a target pressure of the main support body 1604. In this way, the release valve 1632 releases fluid from the main support body 1604 via an engagement with the cord 1634 and protects the main support body 1604 (e.g., against undesirable over pressurization).

### VIII. Overview of Sixth Example Offloader System

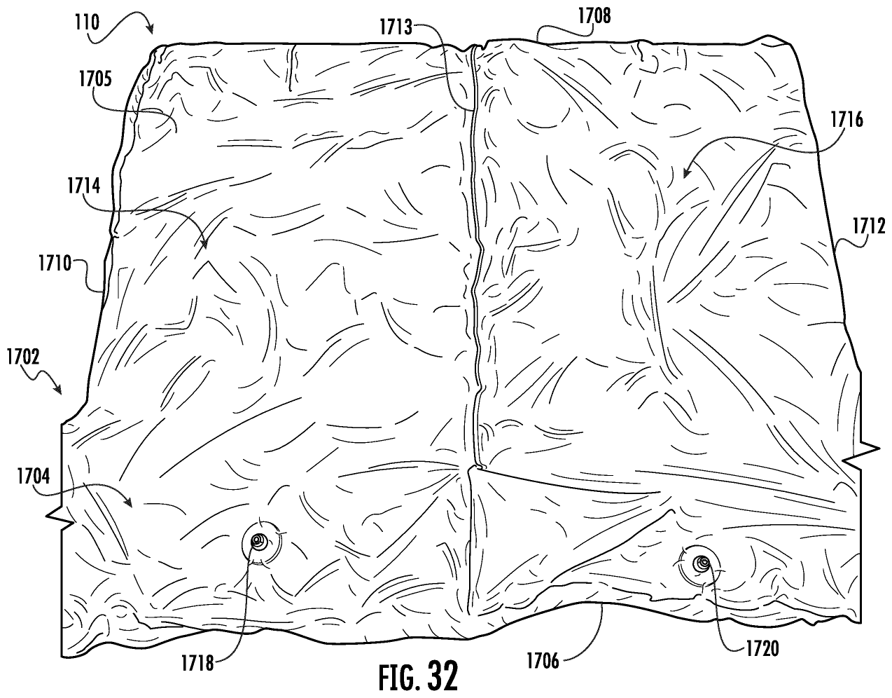

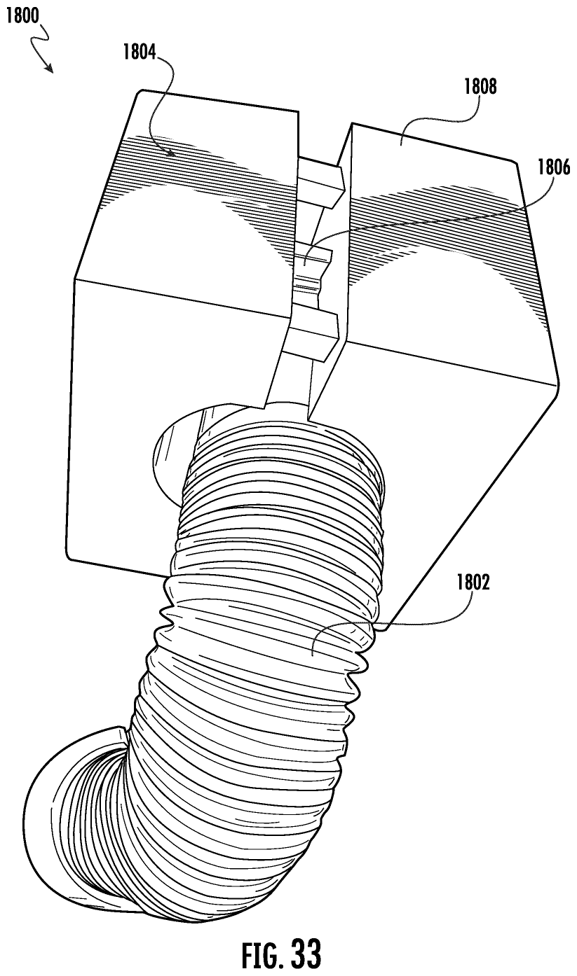

FIGS. 32 and 33 depicts various views of another example offloader system 110, according to an embodiment. The offloader system 110 includes a main support 1702. The main support 1702 is configured to support the body parts 106. As an example, the main support 1702 reduces pressure on the body parts 106 by placing the main support 1702 underneath the body parts 106. The main support 1702 is configured to assist clinicians with turning and positioning procedures. As an example, the main support 1702 adjusts an orientation of the patient without physical burden of the clinician during inflation of the device.

The main support 1702 includes a main support body 1704. Similarly to the embodiments of FIGS. 17-31, the main support 1702 is inflatable such that the main support 1702 may hold a fluid during usage of the offloader system 110. The main support body 1704 is configured to be placed between a patient and a support surface (e.g., bed 102, hospital chair, wheelchair) prior to inflation (e.g., when in a deflated state). The main support body 1204 includes a first sheet 1705 and a second sheet (not shown). The first sheet 1705 is configured to receive (e.g., contact, support, offload) the body parts 106. The first sheet 1705 is positioned opposite of first sheet 1705. The second sheet is configured to receive a top surface of a support surface. The second sheet is coupled to the first sheet 1705 to form a cover. The cover is configured to enclose the internal components of the main support 1402, forming an inflatable cushion assembly capable of holding a fluid.

The first sheet 1705 and the second sheet are formed of a polymeric material. The polymeric material is non-absorbent (e.g., water repellant, cleanable). As an example, the polymeric material may be polyvinyl chloride (PVC), thermoplastic polyurethane (TPU), polyethylene (PE), non-woven polypropylene, polyurethane-coated fabrics, nylon, or various other medical grade materials. In some applications, the first sheet 1705 and the second sheet may be formed of different polymeric materials. In some applications, a portion of the first sheet 1705 and/or the second sheet may feature a coating (e.g., a polyurethane (PU), TPU, or PVC coating) to increase the coefficient of friction of the polymeric material. In other applications, the first sheet 1705 and the second sheet may be formed of different polymeric materials.

The first sheet 1705 and the second sheet may be formed in similar shapes (e.g., geometrically similar shapes). As an example, the first sheet 1705 and the second sheet may be formed in a rounded rectangle. In some applications, the first sheet 1705 and the second sheet may be formed in a square, a rectangle, a circle, an oval, a polygon, or various other shapes. In some embodiments, the first sheet 1705 is identical to the second sheet. In these embodiments, the first sheet 1705 perfectly overlap and cooperates with the second sheet to form the main support body 1704.

As shown in FIG. 32, the main support body 1704 includes formed regions (e.g., edges, periphery of main support 1702). The formed regions define the first sheet 1705 and the second sheet. The formed regions include a first edge 1706, a second edge 1708, a first side edge 1710, and a second side edge 1712. The formed regions are configured to enclose the main support body 1704 to form the inflatable cushion assembly. The formed regions may include sealing materials such as thermoplastic polymers, rubber, adhesives, welded seams, and/or various other materials. In some embodiments, the formed regions are manufactured by heat sealing, radio frequency (RF) welding, ultrasonic welding, adhesive sealing, and/or various other processes.

The main support body 1704 is separated by a first stitched region 1713 to divide the main support body 1704 into a first chamber 1714 and a second chamber 1716. The first stitched region 1713 may include sealing materials such as thermoplastic polymers, rubber, adhesives, welded seams, and/or various other materials. In some embodiments, the first stitched region 1713 is manufactured by heat sealing, radio frequency (RF) welding, ultrasonic welding, adhesive sealing, and/or various other processes. In some embodiments, the first chamber 1714 is configured to support a first portion of the patient 104, while the second chamber 1716 is configured to support a second portion. As an example, the first chamber 1714 may be configured to support a rightmost side (e.g., right shoulder, right side of back, right side of sacrum, right leg) of the patient 104, and the second chamber 1716 may be configured to support a left side (e.g., left shoulder, left side of back, left side of sacrum, left leg) of the patient 104. As another example, the first chamber 1714 may be configured to support the head and upper back of the patient 104, and the second chamber 1716 is configured to support a lower back and sacrum of the patient 104.

The main support body 1704 includes a first air valve 1718 and a second air valve 1720. The first air valve 1718 and the second air valve 1720 are coupled to the first sheet 1705. The first air valve 1718 and the second air valve 1720 are in fluid communication with the main support body 1204 and is configured to facilitate entrance of fluid into the main support body 1704. As an example, the first air valve 1718 is in fluid communication with the first chamber 1714 and the second air valve 1720 is in fluid communication with the second chamber 1716. In some embodiments, the fluid entering the main support body 1704 is a gas. As an example, the fluid may include gases such as atmospheric air, medical grade air, nitrogen, carbon dioxide, or other similar gases.

In some embodiments, the first air valve 1718 and the second air valve 1720 are one-way valves (e.g., check valves). In these embodiments, the first air valve 1718 and the second air valve 1720 are configured to allow a flow of fluid into the main support body 1704 while preventing exit of the fluid during operation. In these embodiments, the main support body 1704 includes pressure-relief valves (not shown) that are coupled to the first sheet 1705 and each respective valve (e.g., the first air valve 1718 and the second air valve 1720). The pressure-relief valves are configured to open and release the fluid when a pressure of the fluid within the first chamber 1714 and the second chamber 1716 are at a target pressure of the main support body 1204. In this way, the pressure-relief valves protect the main support body 1704 (e.g., against undesirable over pressurization). Additionally, the pressure-relief valves may facilitate selective release of the fluid within the first chamber 1714 and the second chamber 1716 to tailor a pressure of the fluid within the main support body 1704 to a target pressure such that the main support body 1704 is tailored for a target application. As an example, after inflating the main support body 1704, a nurse may manipulate the pressure-relief valve to release some of the fluid such that the main support body 1204 is tailored for a target application.

In some embodiments, the first air valve 1718 and the second air valve 1720 are two-way valves (e.g., inflation/deflation valves). The first air valve 1718 and the second air valve 1720 are configured to be opened to allow the fluid to enter the first chamber 1714 and the second chamber 1716 during inflation and exit the main support body 1704 during deflation. As an example, the first air valve 1718 and the second air valve 1720 may have two modes, in which a first mode comprises an inflation position and a second mode comprises a deflation position. A user may transition the first air valve 1718 and/or the second air valve 1720 from a first mode to a second mode by engaging with the first air valve 1718 and the second air valve 1720 (e.g., twisting, pushing, pulling, or removing a cap) to allow a flow of fluid out of the first chamber 1714 and/or the second chamber 1716.

In some embodiments, the first air valve 1718 and the second air valve 1720 may be connected to one or more external pumps. As an example, the one or more external pumps may include an electric compressor pump, a portable electronic blower, a wall-mounted medical air outlet, a manual (e.g., hand or foot) pump, a carbon dioxide (CO₂) cartridge, or various other gas sources. In some embodiments, each camber may be filled with fluid via the same pump or respective pumps.

As shown in FIG. 33, the one or more external pumps includes a pump system 1800. The pump system 1800 is a portable air blower. The pump system 1800 includes a hose 1802 and an adapter 1804 with a male end 1806 and a female end 1808. The male end 1806 may be configured to be inserted into the female end 1808, thereby creating an airtight seal around a respective valve. The adapter 1804 may be configured to control and limit delivery of fluid into a respective valve. The adapter 1804 may be compatible with the first air valve 1718 and the second air valve 1720. The adapter 1804 may facilitate movement of fluid into the first chamber 1714 and the second chamber 1716. In some embodiments, the adapter 1804 may be compatible with the valve 1210 of FIGS. 17-21 or the valve 1408 of FIGS. 22-25.

In some embodiments, the offloader system 110 is automated, such that the main support 1702 inflates and deflates automatically during the length of usage. As an example, the first chamber 1714 and the second chamber 1716 may alternate between an inflated state and a deflated state to automatically offload and turn the patient 104. In some applications, the offloader system 110 may reposition the patient every 2 hours (e.g., “Q2” turns). As an example, the first chamber 1714 inflates via a first pump to turn the patient 104 to a rightmost side for 2 hours, then deflates while the second chamber 1716 inflates via a second pump to turn the patient 104 to a leftmost position for 2 hours. In other applications, the first chamber 1714 and the second chamber 1716 may inflate and deflate simultaneously to support the patient 104.

### IX. Overview of Seventh Example Offloader System

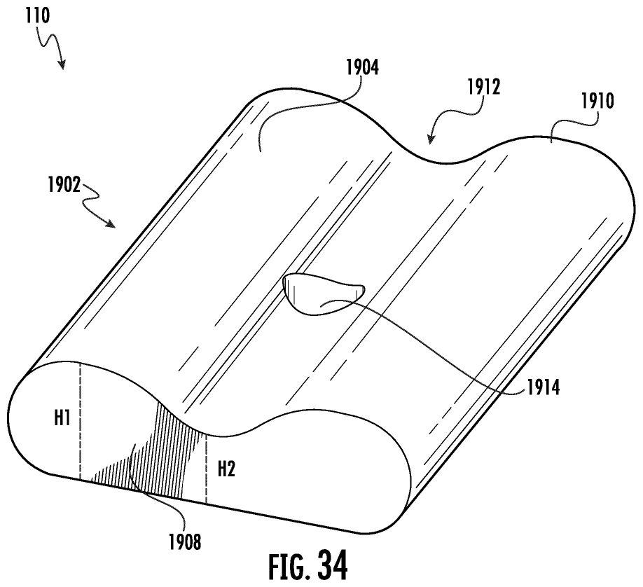

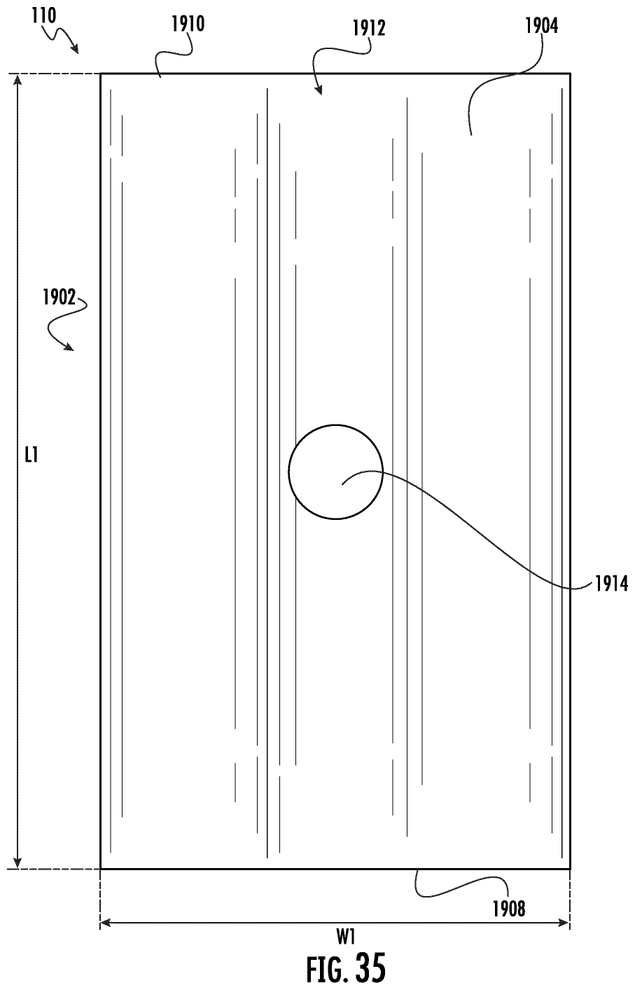

FIGS. 34-37 depict various views of another example offloader system 110, according to an embodiment. The offloader system 110 includes a main support 1902. The main support 1902 is configured to support the body parts 106. As an example, the main support 1902 reduces pressure on the body parts 106 by placing the main support 1902 underneath the body parts 106. The main support 1902 is configured to assist clinicians with turning and positioning procedures. As an example, the main support 1902 adjusts an orientation of the patient without physical burden of the clinician during inflation of the device.

The main support 1902 includes a top face 1904 and a bottom face 1906. The top face 1904 is configured to receive (e.g., contact, support, offload) the body parts 106. The bottom face 1906 is positioned opposite of top face 1904. The bottom face 1906 is configured to receive a top surface of a support surface. In some embodiments, the top face 1904 and the bottom face 1906 have a length L1 and a width W1. The width W1 is 40% to 60% of length L1, inclusive. A first edge 1908 and a second edge 1910 define the width W1, where the second edge 1910 is positioned opposite of the first edge 1908. In some embodiments, the height of the main support 1902 may vary across the width W1 of the main support 1902. As an example, the main support 1902 may include a first height H1 and a second H2, where the second height H2 is 60% to 80% of the first height H1, inclusive.

The top face 1904 and the bottom face 1906 may be formed in different shapes (e.g., geometrically different shapes). As an example, the top face 1904 has a contoured shape with a cavity 1912, while the bottom face 1906 has substantially flat profile. The cavity 1912 extends from the first edge 1908 to the second edge 1910. The cavity 1912 includes a symmetrical, concave indentation (e.g., “U” shape). The cavity 1912 is positioned at a location on the second edge 1212 equidistant from each side edge of the main support 1902. As an example, the portions of the cavity 1912 closest to each side edge may have the first height H1, while the concave portion of the cavity 1912 may have the second height H2, creating the contoured shape on top face 1904. In some embodiments, the cavity 1912 is configured to receive the body parts 106. As an example, the cavity 1912 may support a sacrum (e.g., tailbone) of the patient.

The top face 1904 includes a central aperture 1914. The central aperture 1914 extends from the top face 1904 to the bottom face 1906. The central aperture 1914 is positioned in a portion of the cavity 1912 equidistant from the first edge 1908 and the second edge 1910. The central aperture 1914 is configured to secure body parts 106 with high pressure risk (e.g., boney prominences such as the sacrum, elbows, heels, back of the head), thereby preventing the body parts 106 from contact with the support surface.

In some embodiments, the main support 1902 includes foam. As an example, the foam may be polyurethane (PU), high-resilience (HR) foam, cross-linked polyethylene (XLPE) foam, rubber-based foams, gel foam, or various other foams. In some applications, the main support 1902 may include a gel. As an example, the main support 1902 may include polyurethane (PU) gel, viscoelastic gel, silicone gel, elastomeric gel, or various other gels. In other applications, the main support 1902 is inflatable, in which the top face 1904 and the bottom face 1906 are coupled to form an inflatable cushion assembly. As an example, the top face 1904 and the bottom face 1906 may include a polymeric material such as polyvinyl chloride (PVC), thermoplastic polyurethane (TPU), polyethylene (PE), non-woven polypropylene, polyurethane-coated fabrics, nylon, or various other medical grade materials.

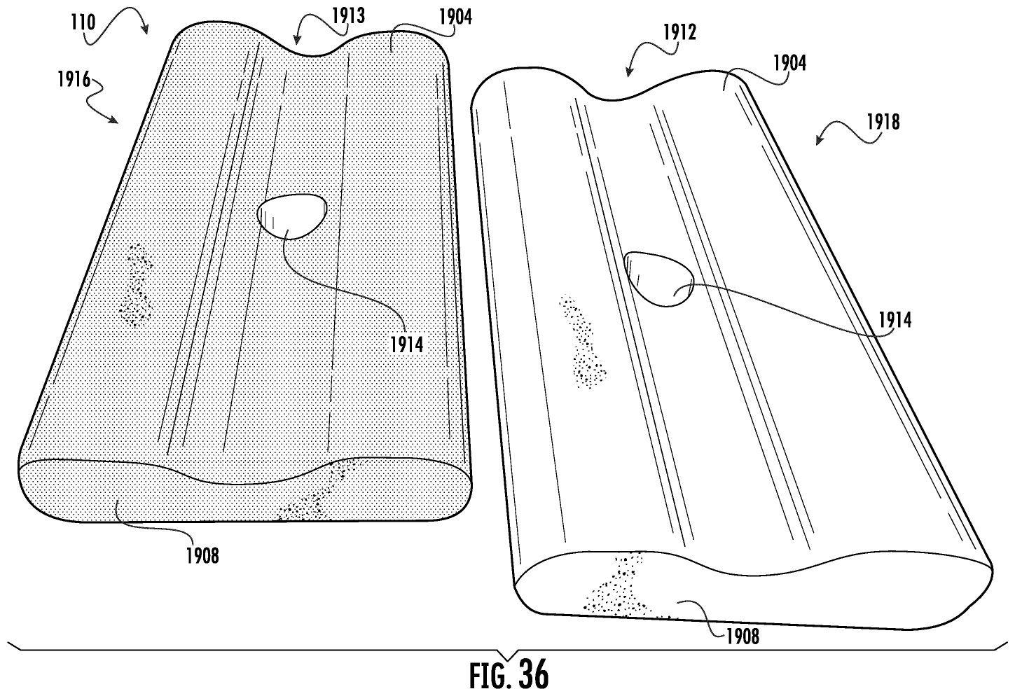

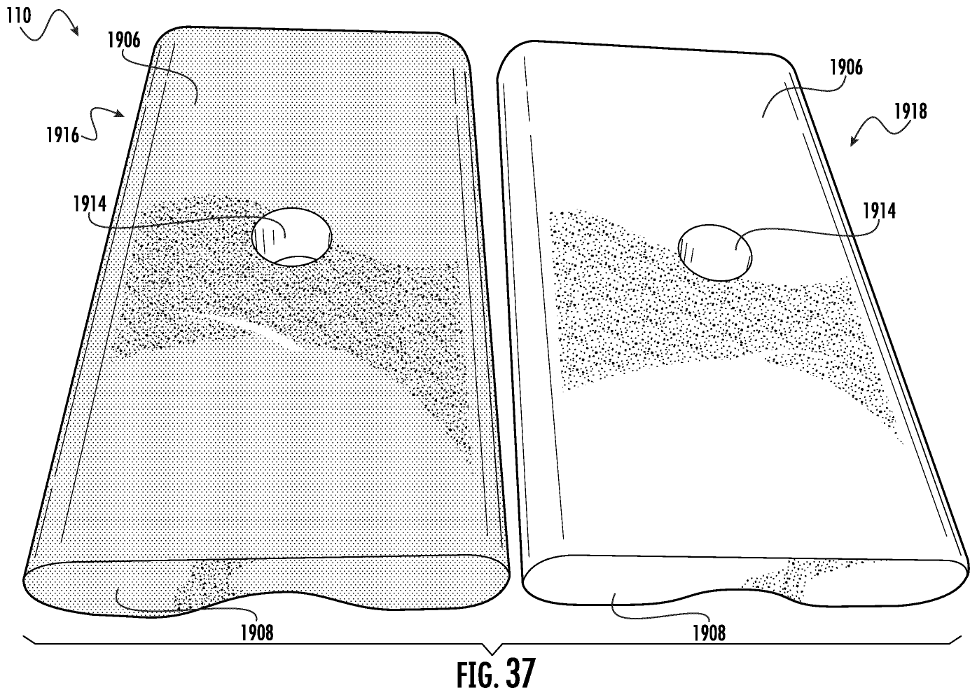

In some embodiments, the main support 1902 may include a surface treatment. As shown in FIGS. 36 and 37, the main support 1902 may coated in a polymeric material to increase friction (e.g., a first surface treatment 1916) or decrease friction (e.g., a second surface treatment 1918) of the main support 1902 relative to the patient 104. As an example, the first surface treatment 1916 may include a coating such as thermoplastic polyurethane (TPU), synthetic rubber, silicone elastomer, polyvinyl chloride (PVC), thermoplastic elastomer (TPE), polyurethane (PU) spray, or various other coatings configured to increase friction of the main support 1902. The first surface treatment 1916 may be configured to grip the body parts 106, thereby preventing shear stress of the skin. As another example, the second surface treatment 1918 may include a coating such as polyurethane (PU), nylon, fluoropolymer, polyvinyl chloride (PVC), thermoplastic elastomer (TPE), or various other high-gloss and/or smooth formulations. The second surface treatment 1918 may be configured to mimic human skin, thereby reducing abrasion against non-intact (e.g., fragile, damaged, weak) skin during placement.

### X. Configuration of Example Embodiments

As utilized herein, the terms “approximately,” “about,” “substantially,” and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the disclosure as recited in the appended claims.

It should be noted that the term “example” and variations thereof, as used herein to describe various embodiments, are intended to indicate that such embodiments are possible examples, representations, or illustrations of possible embodiments (and such terms are not intended to connote that such embodiments are necessarily extraordinary or superlative examples).

The term “coupled” and variations thereof, as used herein, means the joining of two members directly or indirectly to one another. Such joining may be stationary (e.g., permanent or fixed) or moveable (e.g., removable or releasable). Such joining may be achieved with the two members coupled directly to each other, with the two members coupled to each other using a separate intervening member and any additional intermediate members coupled with one another, or with the two members coupled to each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

The term “or,” as used herein, is used in its inclusive sense (and not in its exclusive sense) so that when used to connect a list of elements, the term “or” means one, some, or all of the elements in the list. Conjunctive language such as the phrase “at least one of X, Y, and Z,” unless specifically stated otherwise, is understood to convey that an element may be either X, Y, Z; X and Y; X and Z; Y and Z; or X, Y, and Z (i.e., any combination of X, Y, and Z). Thus, such conjunctive language is not generally intended to imply that certain embodiments require at least one of X, at least one of Y, and at least one of Z to each be present, unless otherwise indicated.

References herein to the positions of elements (e.g., “top,” “bottom,” “above,” “below”) are merely used to describe the orientation of various elements in the FIGURES. It should be noted that the orientation of various elements may differ according to other example embodiments, and that such variations are intended to be encompassed by the present disclosure.

It is important to note that the construction and arrangement of the systems, apparatuses, and methods shown in the various example embodiments is illustrative only. Additionally, any element disclosed in one embodiment may be incorporated or utilized with any other embodiment disclosed herein. For example, any of the example embodiments described in FIGS. 1-37 of this application can be incorporated with any of the other example embodiment described. Although only one example of an element from one embodiment that can be incorporated or utilized in another embodiment has been described above, it should be appreciated that other elements of the various embodiments may be incorporated or utilized with any of the other embodiments disclosed herein.

What is claimed is:

1. An offloader system comprising:
a main support comprising:
a main support body having a main rounded surface with a first edge, and
a main cover extending around the main support body, the main cover formed from a polymeric material; and
an auxiliary support comprising:
an auxiliary support body having an auxiliary rounded surface with a second edge, and
an auxiliary cover extending around the auxiliary support body, the auxiliary cover formed from a polymeric material, the auxiliary cover hingedly coupled to the main cover along the first edge and the second edge so that the auxiliary support is rotatable relative to the main support.

2. The offloader system of claim 1, wherein:
the main support body further comprises:
a main lateral wall contiguous with the first edge, and
a main base wall contiguous with the main lateral wall and the main rounded surface, the main base wall and the main lateral wall separated by a first angle, the first angle being between 70 degrees and 90 degrees, inclusive; and
the auxiliary support body further comprises:
an auxiliary lateral wall contiguous with the second edge, and
an auxiliary base wall contiguous with the auxiliary lateral wall and the auxiliary rounded surface, the auxiliary base wall and the auxiliary lateral wall separated by a second angle, the second angle being between 70 degrees and 90 degrees, inclusive.

3. The offloader system of claim 2, wherein the offloader system has a first position, the main base wall and the auxiliary base wall forming a first base surface, the main rounded surface and the auxiliary rounded surface forming a first top surface opposite the first base surface, the main lateral wall and the auxiliary lateral wall being contiguous.

4. The offloader system of claim 3, wherein the offloader system has a second position, the second position being formed by rotation via the first edge and the second edge, the main lateral wall and the auxiliary lateral wall forming a second base surface, the main base wall and the main rounded surface forming a first apex and the auxiliary base wall and the auxiliary rounded surface forming a second apex, the first apex, the second apex, the first edge, and the second edge defining a receptacle, the receptacle forming a second top surface opposite the second base surface.

5. The offloader system of claim 4, wherein the main rounded surface has a straight portion and a rounded portion, the straight portion contiguous to a portion of the auxiliary rounded surface in the second position.

6. The offloader system of claim 2, further comprising a sheet having a first sheet edge and a second sheet edge contiguous with the first sheet edge, the first sheet edge coupled to the main support body, the sheet being rectangular, the second sheet edge having a sheet length;
wherein the first sheet edge has a main support length;
wherein the sheet length is greater than the main support length and less than 4 times the main support length;
wherein the main cover has a base coefficient of static friction; and
wherein at least a portion of the sheet is formed from a second material, the second material having a sheet coefficient of static friction, the sheet coefficient of static friction greater than 3 times the base coefficient of static friction and less than 5 times the base coefficient of static friction.

7. The offloader system of claim 6, wherein the main support comprises a first engagement member disposed on the main base wall and the sheet comprises a second engagement member disposed on the first sheet edge, the first sheet edge coupled to the main support body via the first engagement member and the second engagement member.

8. A system comprising:
the offloader system of claim 2; and
a bed, the bed having a top bed surface;
wherein a first position of the offloader system comprises the main base wall and the auxiliary base wall in contact with the top bed surface, the main rounded surface and the auxiliary rounded surface facing opposite the top bed surface, and the main lateral wall and the auxiliary lateral wall are contiguous; and
wherein a second position of the offloader system comprises the main lateral wall and the auxiliary lateral wall in contact with the top bed surface, the main base wall and the main rounded surface forming a first apex and the auxiliary base wall and the auxiliary rounded surface forming a second apex and facing opposite the top bed surface, the first apex, the second apex, the first edge, and the second edge defining a receptacle.

9. An offloader system comprising:
a main support comprising:
a main support body having a main ramp surface with a first edge having a first length, and
a main cover extending around the main support body;
a first auxiliary support comprising:
a first auxiliary support body having a first auxiliary ramp surface with a second edge having a second length and a first side surface, and
a first auxiliary cover extending around the first auxiliary support body, the first auxiliary cover hingedly coupled to the main cover along the first edge and the second edge so that the first auxiliary support is rotatable relative to the main support; and
a second auxiliary support comprising:
a second auxiliary support body having a second auxiliary ramp surface with a third edge having a third length and a second side surface facing the first side surface, and
a second auxiliary cover extending around the second auxiliary support body, the second auxiliary cover hingedly coupled to the main cover along the first edge and the third edge so that the second auxiliary support is rotatable relative to the main support;
wherein the second length is 20% to 40% of the first length, inclusive;
wherein the third length is 20% to 40% of the first length, inclusive; and
wherein the first side surface and the second side surface are separated by a fourth length, the fourth length is 20% to 40% of the first length, inclusive.

10. The offloader system of claim 9, wherein the main support body further comprises:
a main base wall contiguous with the first edge;
a main lateral wall contiguous with the main base wall, the main base wall and the main lateral wall separated by a first angle, the first angle being between 70 degrees and 90 degrees, inclusive; and
a main top wall contiguous with the main lateral wall and the main ramp surface, the main top wall and the main ramp surface separated by a second angle, the second angle being between 50 degrees and 80 degrees, inclusive.

11. The offloader system of claim 10, wherein the first auxiliary support body further comprises:
a first auxiliary base wall contiguous with the second edge;
a first auxiliary lateral wall contiguous with the first auxiliary base wall, the first auxiliary base wall and the first auxiliary lateral wall separated by a third angle, the third angle being between 70 degrees and 90 degrees, inclusive; and
a first auxiliary top wall contiguous with the first auxiliary lateral wall and the first auxiliary ramp surface, the first auxiliary top wall and the first auxiliary ramp surface separated by a fourth angle, the fourth angle being between 50 degrees and 80 degrees, inclusive.

12. The offloader system of claim 11, wherein the second auxiliary support body further comprises:
a second auxiliary base wall contiguous with the first edge;
a second auxiliary lateral wall contiguous with the second auxiliary base wall, the second auxiliary base wall and the second auxiliary lateral wall separated by a fifth angle, the fifth angle being between 70 degrees and 90 degrees, inclusive; and
a second auxiliary top wall contiguous with the second auxiliary lateral wall and the second auxiliary ramp surface, the second auxiliary top wall and the second auxiliary ramp surface separated by a sixth angle, the sixth angle being between 50 degrees and 80 degrees, inclusive.

13. The offloader system of claim 12, further comprising:
a first strap coupled to the main lateral wall and the first auxiliary lateral wall, the first strap configured to extend over the main top wall and the first auxiliary top wall; and
a second strap, the second strap coupled to the main lateral wall and the second auxiliary lateral wall, the second strap configured to extend over the main top wall and the second auxiliary top wall.

14. The offloader system of claim 12, wherein the offloader system has a first position, the main base wall, the first auxiliary base wall, and the second auxiliary base wall forming a first base surface and the main ramp surface, the first auxiliary ramp surface, and the second auxiliary ramp surface defining a receptacle, the receptacle forming a first top surface opposite the first base surface.

15. The offloader system of claim 14, wherein the offloader system has a second position, the second position being formed by rotation via the first edge, the second edge, and the third edge, the main lateral wall, the first auxiliary lateral wall, and the second auxiliary lateral wall forming a second base surface and the main ramp surface, the first auxiliary ramp surface, and the second auxiliary ramp surface forming a second top surface opposite of the second base surface, the first auxiliary base wall and the second auxiliary base wall contiguous with the main base wall.

16. A system comprising:
the offloader system of claim 12; and
a bed, the bed having a top bed surface;
wherein a first position of the offloader system comprises the main base wall, the first auxiliary base wall, and the second auxiliary base wall in contact with the top bed surface and the main ramp surface, the first auxiliary ramp surface, and the second auxiliary ramp surface defining a receptacle facing opposite the top bed surface; and
wherein a second position of the offloader system comprises the main lateral wall, the first auxiliary lateral wall, and the second auxiliary lateral wall in contact with the top bed surface and the main ramp surface, the first auxiliary ramp surface, and the second auxiliary ramp surface facing opposite the top bed surface.

17. An offloader system comprising:
a main support defined by a first edge and a second edge opposite the first edge, the main support comprising:
an inner core comprising a foam and defining a cavity positioned at the second edge,
a first sheet comprising a polymeric material, and
a second sheet comprising the polymeric material, the second sheet coupled to the first sheet along a periphery of the first sheet and cooperating with the first sheet to form a cover, the cover extending around and enclosing the inner core to form an inflatable cushion; and
a first valve coupled to the first sheet and the second sheet and positioned along the first edge, the first valve being in fluid communication with the inflatable cushion and configured to facilitate flow of fluid into the inflatable cushion.

18. The offloader system of claim 17, wherein the inner core further comprises:
a first face,
a second face opposite the first face,
an aperture extending into the inner core, and
a first aperture extending into the inner core, the first aperture positioned between the first face and the second face at the first edge.

19. The offloader system of claim 18, wherein the offloader system further comprises a cartridge holding a first fluid, the first fluid being a gas, the cartridge positioned in the first aperture, such that a first end of the cartridge is positioned adjacent to the first valve, where the first end is configured to facilitate movement of fluid from the cartridge to the main support during an engagement with the first valve.

20. The offloader system of claim 19, wherein the offloader system further comprises a cord extending from the first valve, such that the first valve is configured to engage with the first end of the cartridge via an engagement with the cord.
